(19) United States
(12) Patent Application Publication
(10) Pub. No.: US 2018/0063205 A1
(43) Pub. Date: Mar. 1, 2018

(54) MIXED REALITY COLLABORATION

(71) Applicant: AUGRE MIXED REALITY TECHNOLOGIES, LLC, Naples, FL (US)

(72) Inventor: Christian James French, Naples, FL (US)

(21) Appl. No.: 15/686,975

(22) Filed: Aug. 25, 2017

Related U.S. Application Data
(60) Provisional application No. 62/381,159, filed on Aug. 30, 2016.

(51) Int. Cl. H04L 29/06; G06T 19/00

(52) U.S. Cl. CPC H04L 65/1073; G06T 19/006; G06F 3/04815; H04L 65/1069; H04L 65/403

(57) ABSTRACT

Mixed reality collaboration applications and a mixed reality collaboration platform providing mixed reality collaboration are described. The platform can include a data resource with supported device information, registered user information, and session data stored on the data resource. Two or more devices (e.g., a first user device and a second user device) with different operating systems can register with the platform. The platform can store registration information, such as user device information and user information, received from the two or more devices in the data resource as part of the registered user information. The platform can receive, from the second user device, session data in a format compatible with the second user device operating system. The platform can then access the supported device information and communicate the session data to the first user device according to the API calls for the first user device.

### CROSS REFERENCE TO RELATED APPLICATION

This application claims the benefit of U.S. Provisional Application Ser. No. 62/381,159, filed Aug. 30, 2016.

### BACKGROUND

There are many practical applications and methods to which a person can find and connect with professionals, as well as methods of communication and information sharing. For example, physical books with contact information, basic details, and organization are hand delivered to people's houses. In addition, internet based applications exist for finding services and service providers locally. People regularly discover services, pay for advertisements and share skills with the local community. This exchange of goods is normally local, especially for services like plumbing and mechanics—services that are vital to the physical surrounding of consumers and community members. When a service is needed, e.g. a mechanic, the customer searches newspapers, yellow pages, the internet, and applications. They may additionally request recommendations, hear recommendations via word of mouth, view reviews and ratings online, and fact check information before they make their decision on what service provider they are going to use; after which they will follow up by going to the business or having a professional come to them. This requires time and effort largely on the consumer, and partially on the service provider when they make the effort to advertise their service across hundreds of websites, newspapers, and media outlets. Efforts have been made to mitigate the time required in finding the right services, knowing if the consumer is getting a good deal and whether or not these services are right for them. Internet-based search providers and review websites have taken some stress out of the discovery of services but have not eliminated the need to do some detailed searching.

In addition to making discovery easier on both parties involved, there are services that have been incorporated into fully online based delivery methods. For example, writing and editing essays have become mostly software based with some services offering comprehensive analysis online by submitting papers and having a reviewed version sent back to the user. Online support groups offer web-based services for talking with professionals over instant message, voice or video chat. These offer consumers with a choice to reach out and connect with professionals in remote locations, offering a wider variety of providers rather than limiting them to the providers local to their area. Not all services have had the ability to be provided over the internet with the mediums that are employed. A doctor needs to see a person before they may provide a medical analysis. Even with video and instant message communications, some information is cumbersome to explain or demonstrate over the internet. This limitation is one of the reasons why some services have not or are not fully available or pertinent online.

The internet has, however, vastly improved the way information is shared and accessed. Given this dramatic accessibility of information and communication sharing, there are now hundreds—if not thousands—of ways for people to communicate, share, access, store, and use their data. There are websites, applications, and general storage solutions to many of life's communication and data transfer needs, as well as hundreds of ways for people to find each other, share ideas with one another and connect across vast distances. Although this method offers a rich and diverse way to communicate, it is still currently limited to flat screens and 2-dimensional display ports, or two-way voice streaming that give users the impression of being close, but not being together in the same room. In professional settings, most information is manually sent to an employer or business via email or fax. Data is available and stored in many different ways, but deciding when to share data and with whom has not been advanced as rigorously as the methods of communication.

Virtual and augmented reality devices have created new ways to explore information, deliver content and view the world. Many developers are creating services, content, methods, delivery, games and more for these devices. Some developers have gone a step further and created indexed databases of games available to specific devices. When locating services or applications made for these devices, significant amounts of time and effort are needed for each person to search online, through magazines and news articles, through application store archives, and anywhere in between in order to find what is available and what has already been created for their platforms.

### BRIEF SUMMARY

Mixed reality collaboration applications and a mixed reality collaboration platform providing mixed reality collaboration are described.

The collaboration platform can establishes a link between two different users and ease the access to available services and discovering of those services using a plurality of devices, with a focus on the connection and sharing of environment being linked to mixed reality head mounted displays.

The platform can include a data resource with supported device information, registered user information, and session data stored on the data resource. The supported device information can indicate devices and operating systems that the system can support and their corresponding application programming interface (API) calls. The registered user information can include user identifiers and device information. The session data can include, but is not limited to, three-dimensional (3D) map data, environment data (such as camera angle or directional orientation), geographic location data, sound data, video data, asset data, manipulation data, connection status data, time data, progress data, and preference data.

Two or more devices can register with the platform. The two devices can be two different devices with different operating systems. The platform can store registration information received from a first user device and registration information received from a second user device in the data resource as part of the registered user information. The registration information received from the first user device includes at least first user device information and first user information; and the registration information received from the second user device includes at least second user device information and second user information.

The platform can receive, from the second user device, session data in a format compatible with the second user device operating system. The platform can then access the supported device information and communicate the session data to the first user device according to the API calls for the first user device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment in which various embodiments of the invention may be practiced.

FIG. 2 illustrates an example scenario for providing mixed reality collaboration.

FIG. 3 illustrates an example process flow for providing mixed reality collaboration according to an embodiment of the invention.

FIGS. 4A-4D illustrate example process flows for providing mixed reality collaboration.

FIG. 5 illustrates a conceptual scenario in which various embodiments of the invention may be practiced.

FIG. 6 illustrates an example scenario of mixed reality collaboration.

FIG. 7 illustrates an example scenario of mixed reality collaboration with progress tracking.

FIG. 8 illustrates example scenarios of access restriction for mixed reality collaboration.

FIGS. 9A and 9B illustrate example scenarios of mixed reality collaboration for business management.

FIG. 10 illustrates an example scenario for providing mixed reality collaboration.

FIGS. 11A and 11B illustrate example scenarios of mixed reality collaboration for on-demand service/training.

FIG. 12 illustrates an example scenario of mixed reality collaboration for a live event.

FIG. 13 illustrates an example scenario of mixed reality collaboration for events.

FIG. 14 illustrates an example scenario of mixed reality collaboration for an interview.

FIG. 15 illustrates an example scenario for a non-real-time session.

FIGS. 16A and 16B illustrate example scenarios of mixed reality collaboration for real-time training.

FIGS. 17A and 17B illustrate example scenarios for non-real-time training.

FIGS. 18A and 18B illustrate example scenarios for education.

FIG. 19 illustrates an example scenario for a personal view portal.

FIG. 20 illustrates a conceptual benefit of the platform.

FIG. 21 illustrates an example computing system of a holographic enabled device.

FIG. 22 illustrates components of a computing device that may be used in certain implementations described herein.

FIG. 23 illustrates components of a computing system that may be used to implement certain methods and services described herein

### DETAILED DESCRIPTION

Mixed reality collaboration applications (“collaboration applications”) and a mixed reality collaboration platform (“collaboration platform”) providing mixed reality collaboration are described.

The collaboration platform can establishes a link between two different users and ease the access to available services and discovering of those services using a plurality of devices, with a focus on the connection and sharing of environment being linked to mixed reality head mounted displays.

The platform can include a data resource with supported device information, registered user information, and session data stored on the data resource. The supported device information can indicate devices and operating systems that the system can support and their corresponding application programming interface (API) calls. The registered user information can include user identifiers and device information. The session data can include, but is not limited to, three-dimensional (3D) map data, environment data (such as camera angle or directional orientation), geographic location data, sound data, video data, asset data, manipulation data, connection status data, time data, progress data, and preference data.

Two or more devices can register with the platform. The two devices can be two different devices with different operating systems. The platform can store registration information received from a first user device and registration information received from a second user device in the data resource as part of the registered user information. The registration information received from the first user device includes at least first user device information and first user information; and the registration information received from the second user device includes at least second user device information and second user information.

The platform can receive, from the second user device, session data in a format compatible with the second user device operating system. The platform can then access the supported device information and communicate the session data to the first user device according to the API calls for the first user device.

The term “mixed reality device” will be used to describe all devices in the category of “virtual reality heads-up display device”, “augmented reality heads-up display device”, or “mixed reality heads-up display device”. Examples of mixed reality devices include, for example, Microsoft HoloLens®, HTC VIVE™, Oculus Rift®, and Samsung Gear VR®.

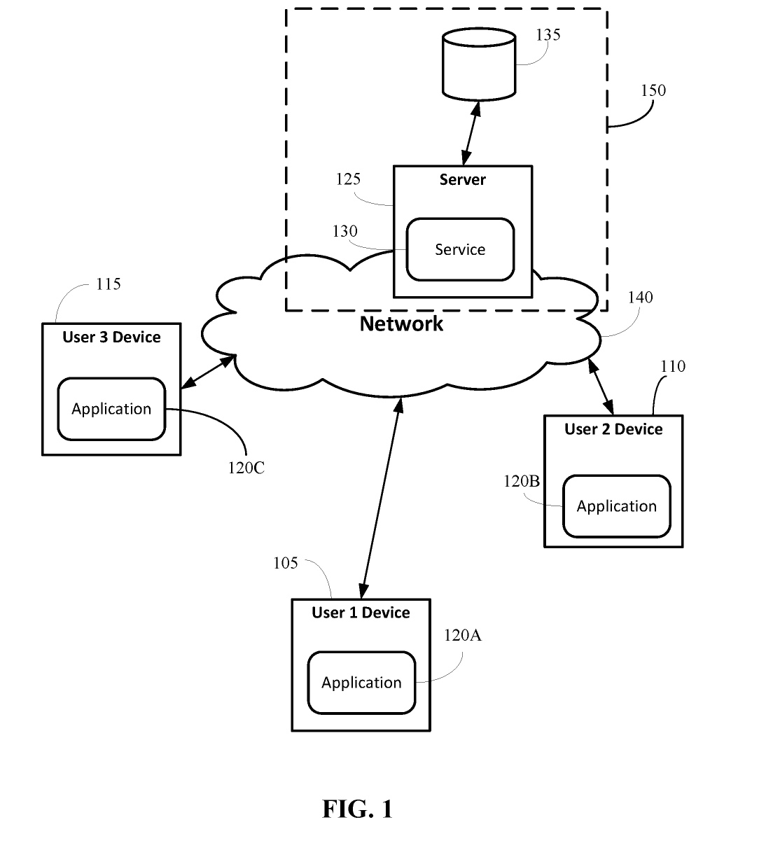

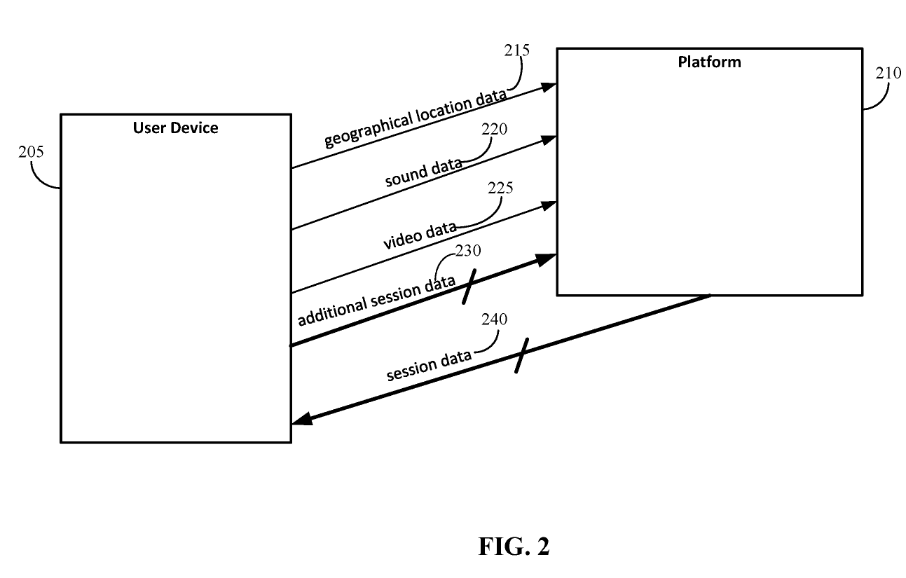

FIG. 1 illustrates an example operating environment in which various embodiments of the invention may be practiced; and FIG. 2 illustrates an example scenario for providing mixed reality collaboration.

Referring to FIG. 1, the example operating environment may include two or more user devices (e.g., a first user device 105, a second user device 110, and a third user device 115), a mixed reality collaboration application 120 (e.g., mixed reality collaboration application 120A, mixed reality collaboration application 120B, and mixed reality collaboration application 120C), a mixed reality collaboration server 125, a mixed reality collaboration service 130, a data resource 135, and a network 140.

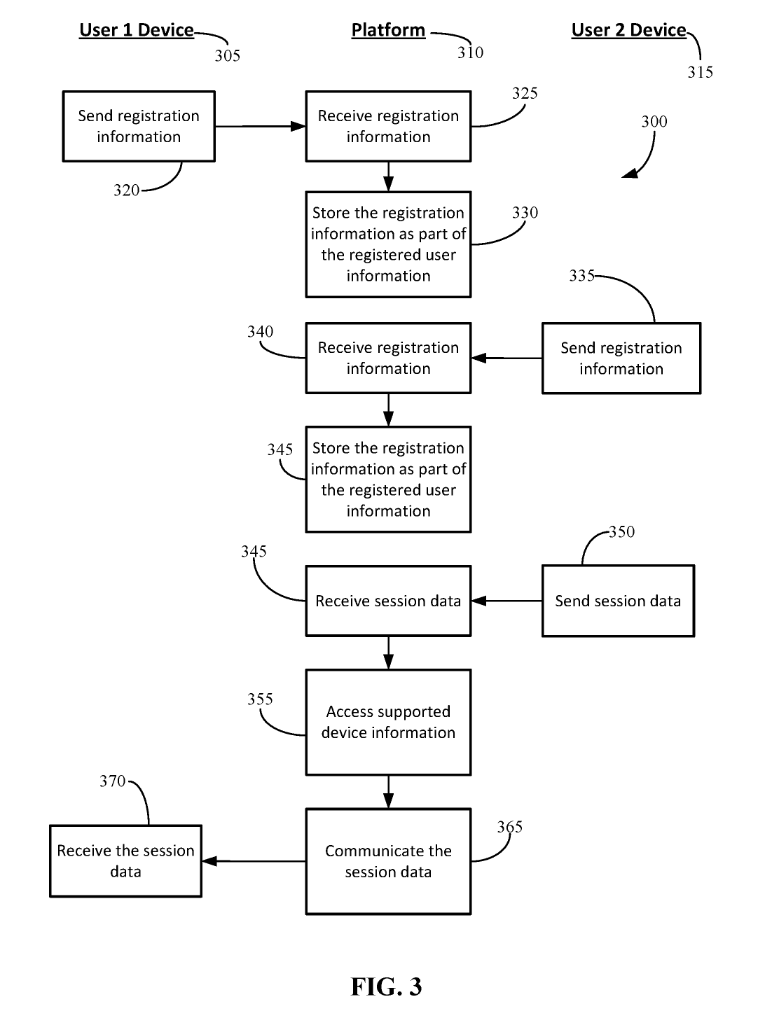

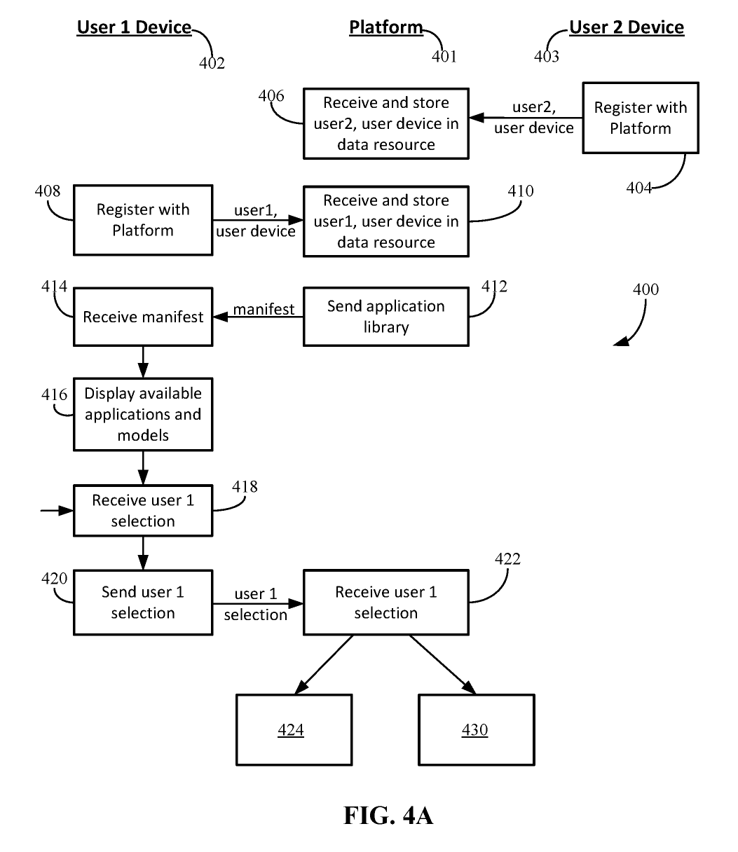

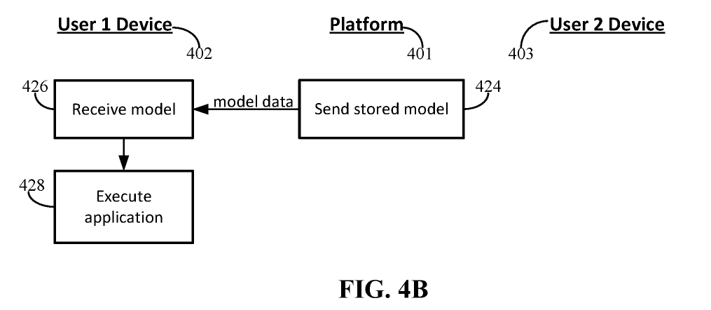

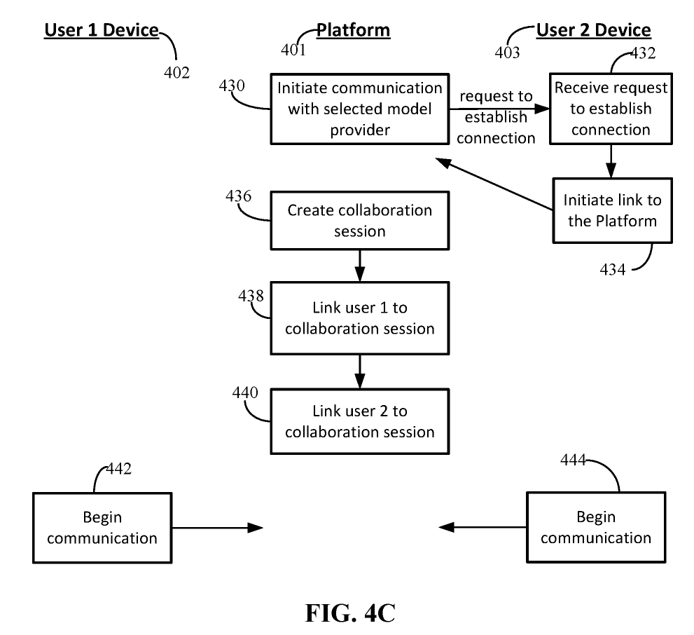

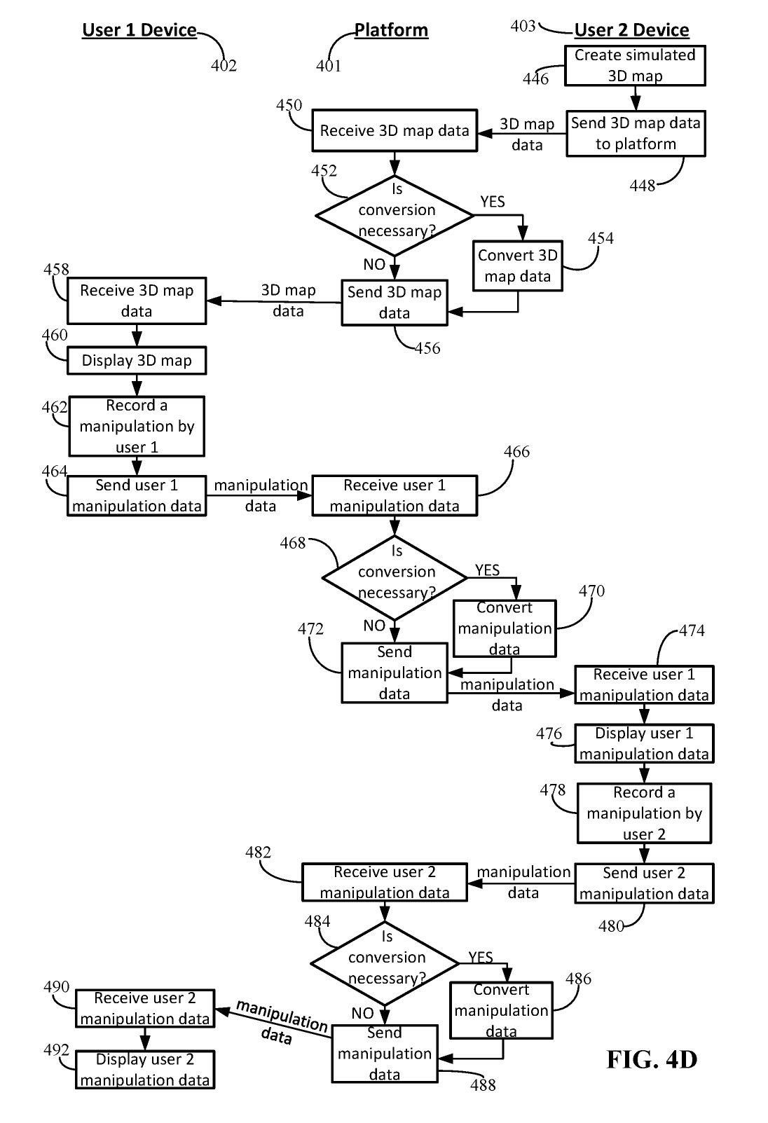

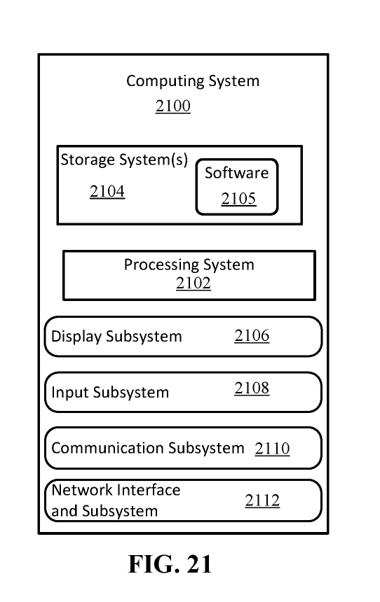

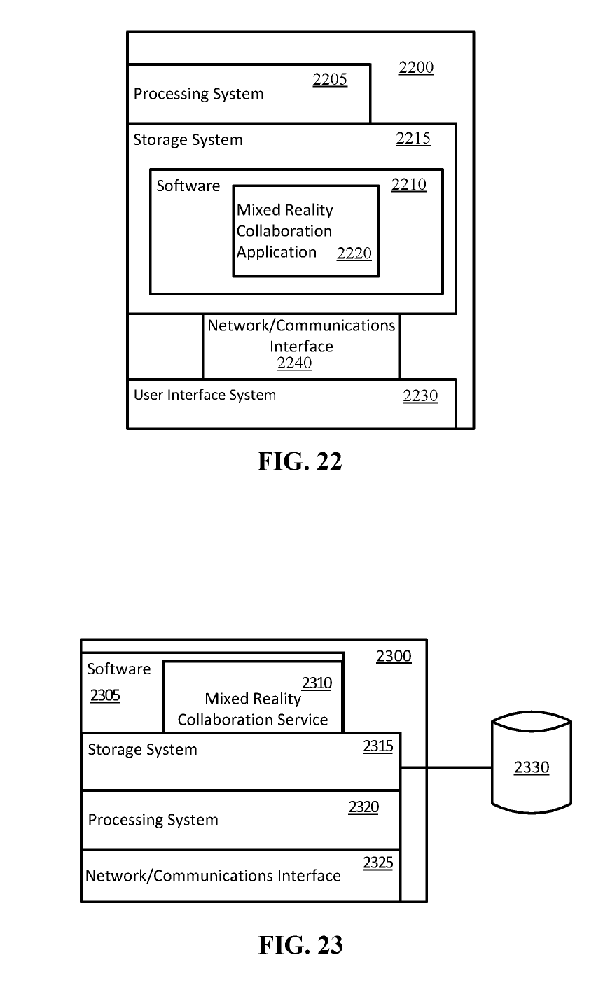

The mixed reality collaboration service 130 performing processes, such as illustrated in FIG. 3 and FIGS. 4A-4D, can be implemented by a mixed reality collaboration platform 150, which can be embodied as described with respect to computing system 2300 as shown in FIG. 23 and even, in whole or in part, by computing systems 2100 or 2200 as described with respect to FIGS. 21 and 22. Platform 150 includes or communicates with the data resource 135, which may store structured data in the form, for example, of a database, and include supported device information, registered user information, and session data.

The supported device information can include, but is not limited to, devices and operating systems that the system can support for mixed reality collaboration. The supported device information can also include API calls corresponding to the supported devices. The registered user information can include, but is not limited to, user identifiers and device information for any user accessing the mixed reality collaboration application 120. The session data can include, but is not limited to, three-dimensional (3D) map data, environment data (such as camera angle or directional orientation), geographic location data, sound data, video data, asset data, manipulation data, connection status data, time data, progress data, and preference data. The 3D map data can define a virtual environment associated with a user. The manipulation data can include any type of change or action taken within the virtual environment. For example, manipulation data could include data about a user walking across a room or a user lifting an object within the virtual environment. It should be understood that this information may be stored on a same or different resource and even stored as part of a same data structure. In some cases, the platform can track the session data.

The information may be received through a variety of channels and in a number of ways. A user may interact with the user device running the collaboration application 120, through a user interface (UI) displayed on a display associated with the user device or via projection. The user device (e.g., the first user device 105, the second user device 110, and the third user device 115) is configured to receive input from a user through, for example, a keyboard, mouse, trackpad, touch pad, touch screen, microphone, camera, eye gaze tracker, or other input device.

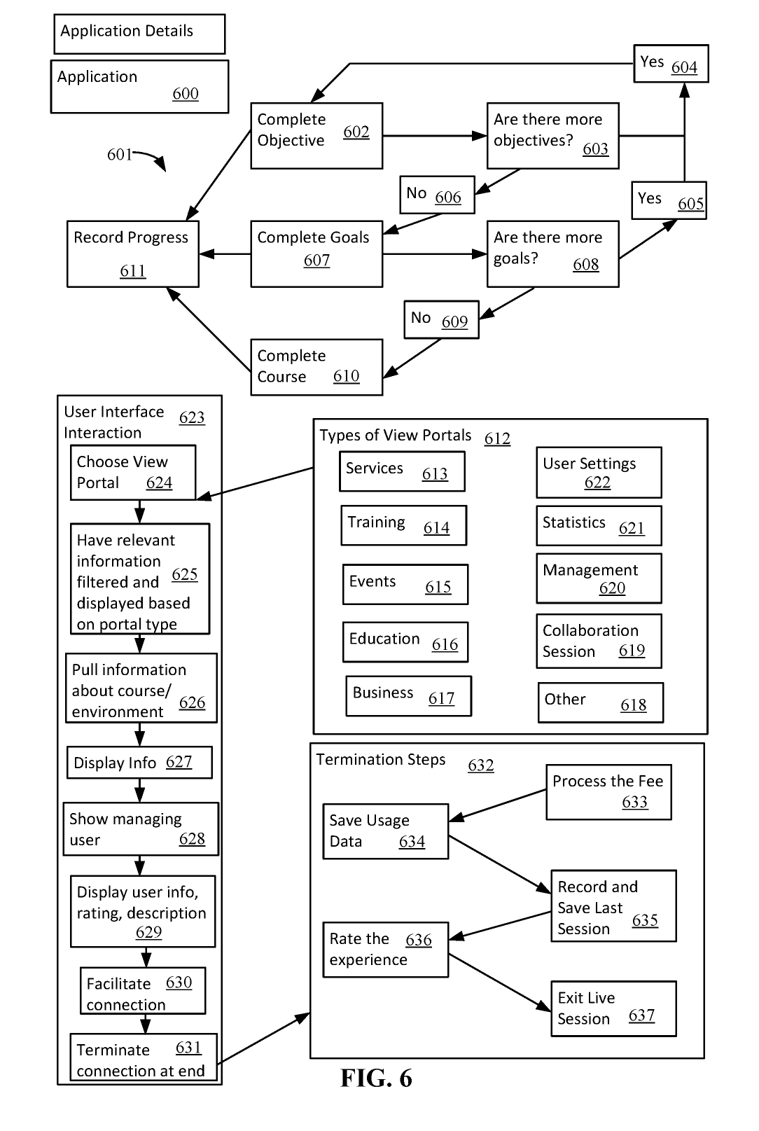

The UI enables a user to interact with various applications, such as the collaboration application 120, running on or displayed through the user device. For example, UI may include a variety of view portals for users to connect to a variety of mixed reality collaboration models (“models”). The view portals may also be used to search for available models. This can support the scenario described in, for example, FIG. 6. Generally, the UI is configured such that a user may easily interact with functionality of an application. For example, a user may simply select (via, for example, touch, clicking, gesture or voice) an option within the UI to perform an operation such scrolling through the results of the available models of the collaboration application 120.

According to certain embodiments of the invention, while the user is selecting collaboration models and carrying out collaboration sessions in the UI, user preferences can be stored for each session. For example, when a user selects a collaboration model or enters a search term in the collaboration application 120, the user preference can be stored. The storing of the user preferences can be performed locally at the user device and/or by the platform 150. User preferences and other usage information may be stored specific for the user and collected over a time frame. The collected data may be referred to as usage data. The collaboration application 120 may collect the information about user preferences as well as other activity user performs with respect to the collaboration application 120. Usage data can be collected (with permission) directly by the platform 150 or first by the collaboration application 120. It should be understood that usage data does not require personal information and any information considered to be personal or private would be expected to be expressly permitted by the user before such information was stored or used. The usage data, such as user preferences, can be stored in the data resource 135 as part of the session data or registered user information.

A user may include consumers or creators of models. Consumers may be member users and creators may be a model provider, such as a business supervisor, an education instructor, or an event coordinator. In some cases, members can have access to their own information and can manage their training paths. The business supervisors and education instructors can create classes for assigning lessons to member users in groups, access and manage the member users' progress, and provide collaborative environments with shared content that is easily accessible to each member user in the groups. The event coordinators can create and share events that other users (e.g., members) can view and browse (and subsequently connect), or save for a later time when the event is live.

Communication to and from the platform 150 may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

The network 140 can be, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network 140 may include one or more connected networks (e.g., a multi-network environment) including public networks, such as the Internet, and/or private networks such as a secure enterprise private network. Access to the network 140 may be provided via one or more wired or wireless access networks as will be understood by those skilled in the art.

As will also be appreciated by those skilled in the art, communication networks can take several different forms and can use several different communication protocols. Certain embodiments of the invention can be practiced in distributed-computing environments where tasks are performed by remote-processing devices that are linked through a communications network. In a distributed-computing environment, program modules can be located in both local and remote computer-readable storage media.

The user devices (such as the first user device 105, the second user device 110, and the third user device 115, or other computing devices being used to participate in a collaboration session) may be embodied as system 2100 or system 2200 such as described with respect to FIGS. 21 and 22 and can run the collaboration application 120. The user devices can be, but are not limited to, a personal computer (e.g. desktop computer), laptop, personal digital assistant (PDA), video game device, mobile phone (or smart phone), tablet, slate, terminal, holographic-enabled device, and the like. It should be apparent that the user devices may be any type of computer system that provides its user the ability to load and execute software programs and the ability to access a network, such as network 140. However, the described platform and application systems are preferably particularly suited for and support mixed reality environments. The first user device 105, the second user device 110, and the third user device 115 may or may not include the same types of devices (or systems) and they may or may not be of a same form. For example, the first user device 105 may be a Microsoft HoloLens® device, the second user device 110 may be a HTC VIVE™ device, and the third user device 115 may be an Oculus Rift® device.

In some cases, the virtual environments may be displayed through a holographic enabled device implemented as a head mounted device (HMD). The holographic enabled device may be implemented as a see-through, mixed reality display device. Through the use of a holographic-enabled device, the user can display the virtual environment received from the platform 150 and transformed into holographic representations, which may be overlaid in appearance onto the surfaces of the room.

The collaboration application 120 can run on a holographic-enabled device in a similar manner to any other computing device; however, on the holographic-enabled device, the graphical user interface for the collaboration application 120 can be anchored to an object in the room or be made to follow the user of the holographic-enabled device. When implementing the holographic-enabled device as a head-mounted display system, gaze, gesture, and/or voice can be used instead of a mouse, keyboard or touch.

The platform 150 can facilitate the use of a plurality of virtual reality, augmented reality, and mixed reality devices. These devices can all have a combination of recording devices (audio/visual devices that record the environment) and record user interactions in space. Advantageously, these devices can be leveraged fully by using them to send, receive and interpret data from other devices to allow connected users to interact with one another as though they were in the same room.

The collaboration application 120 can be stored on the user device (e.g., a client-side application) or accessed as a web-based mixed reality collaboration application (e.g., running on a server or hosted on a cloud) using a web browser (e.g., a standard internet browser), and the application's interface may be displayed to the user within the web browser. Thus, the application may be a client-side application and/or a non-client side (e.g., a web-based) application. The collaboration application 120 can communicate with the platform 150.

A mobile application or web application can be provided for facilitating mixed reality collaboration. The mobile application or web application communicates with the mixed reality collaboration platform to perform the mixed reality collaboration. The mobile application or web application, running on a user device can include features such as image capture and display. A graphical user interface can be provided through which user preferences and selections can be made and mixed reality collaboration sessions can be displayed.

The collaboration application 120 can support functionality, for example, for on-demand training, live event viewing, in-person interviews with shared resources, pre-recorded lessons to teach concepts in real environments using virtual assets, teaching students or employees new skills or training them on certain equipment, measuring progress of learned expertise or skill levels, generating reports of use and knowledge, gain certifications by performing lessons and being graded on it, finding and joining groups of collective individuals based on certain topics and ideas, and sharing information in a café style environment virtually, discovering training documentation on new purchases or equipment in the home or office, connecting and getting advice from professionals, and developing hands-on skills anywhere there is an internet connection without the use of specialized physical environments.

The mixed reality collaboration application 120 can include a variety of 3D models and assets. The models can include, for example, a real-time model and a non-real-time model. The models can be created by an architectural 3D modeling software, and brought into the collaboration application 120. Assets are the individual objects that can be used within the models, such as a lamp or a text field. Each object inside of the model is an asset, which can be moved, manipulated (e.g., a color of the asset can be changed), removed, and seen by all the users. The models can be made up of a collection of various assets. Different lighting assets can also be used within the models to create an environment similar to the real world. The models can range from a small house, to a large industrial building, like an airport. The models may also be recreations of the physical world surrounding the user. Scans of the immediate area are converted into 3D assets and rendered as though they are separate objects to other users.

Referring to FIG. 2, a user device 205 can communicate with a platform 210 to participate in a mixed reality collaboration session. The user device 205 may be any of the user devices (e.g., the first user device 105, the second user device 110, and the third user device 115) described in FIG. 1; and the platform 210 may be platform 150 as described in FIG. 1. In some cases, the users of the collaboration session may first be authenticated using a log-in identifier and password.

During the collaboration session, the user device 205 may send session data to the platform 210. When the user device 205 sends the session data, the session data will be sent in a format compatible with the operating system of the user device 205. Thus, the session data will be sent according to the API calls for the user device 205. For example, if the user device 205 is a Microsoft HoloLens®, the user device 205 can send geographical location data (215) to the platform 210 using a location API and a core functionality API for the Microsoft HoloLens®. In another example, the user device 205 can send sound data (220) to the platform 210 using a sound API and the core functionality API corresponding to the type of the user device 205; and the user device 205 can send video data (225) to the platform 210 using a video API and the core functionality API corresponding to the type of the user device 205. The user device 205 can also send any additional relevant session data (230) to the platform 210 in this way.

When the platform 210 receives the session data from the user device 205, the platform 210 can access the supported device information in a data resource, such as data resource 135 described in FIG. 1, to determine if any conversion of the session data is needed. The platform 210 can convert the received session data to a format compatible with the operating system of any device linked to the collaboration session. Advantageously, the collaboration session can be cross platform and can include multiple users on different devices with different operating systems.

The user device 205 can also receive (240) session data from the platform 210. When the user device 205 receives the session data from the platform 210 the session data will be in a format compatible with the operating system of the user device 205, regardless of what type of device (or operating system) sent the session data.

FIG. 3 illustrates an example process flow for providing mixed reality collaboration according to an embodiment of the invention. Referring to FIG. 3, a first user device 305 can send registration information (320) to a platform 310. As previously discussed, the registration information can include information about the first user device 305, as well as information about the first user, such as a first user identifier. In response to receiving the registration information (325) from the first user device 305, the platform 310 can store the registration information in a data resource as part of the registered user information (330). A second user device 315 can also send registration information (335) to the platform 310. The registration information sent from the second user device 315 can include information about the second user device 315, as well as information about the second user, such as a second user identifier. In response to receiving the registration information (340) from the second user device 315, the platform 310 can store the registration information in the data resource as part of the registered user information (345). The registration information may be sent to the platform 310 by the user devices at any time during the process 300.

The platform 310 can then initiate communication between the first user device 305 and the second user device 315. Once communication has been initiated, the second user device 315 can send session data (350) to the platform 310. The session data sent from the second user device 315 is in a format compatible with the second user device operating system. As previously described, the session data can include a variety of data, such as 3D map data, environment data, geographic location data, sound data, video data, asset data, manipulation data, connection status data, time data, progress data, and preference data. In some cases, the user device information may be sent along with the session data.

When the platform 310 receives the session data (355) from the second user device 315, the platform 310 can then access supported device information (360) in the data resource. As previously discussed, the supported device information indicates what devices and operating systems the platform 310 can support, as well as their corresponding API calls. The platform 310 can communicate the session data (365) received from the second user device 315 to the first user device 305 according to the API calls for the first user device 305. The first user device 305 can receive the session data from the platform 310 in a format compatible with the first user device operating system.

The platform 310 can determine the correct API calls for the first user device 305 a variety of ways. For example, the platform 310 can determine the type of device for the first user device 305 using the user device information, either received with the session data or by accessing the registered user information for the first user device 305. Using the user device information, the platform 310 can then determine the corresponding API calls for the first user device 305 and communicate the session data according to those API calls.

In some cases, the session data can be tracked. The session data can be stored in the data resource for use in later collaboration sessions.

FIGS. 4A-4D illustrate example process flows for providing mixed reality collaboration. A collaboration platform 401 may provide mixed reality collaboration between at least a first user device 402 and a second user device 403. In FIGS. 4A-4D, the first user, associated with the first user device 402, may be the user of a model and the second user, associated with the second user device 403, may be the model provider. Although FIGS. 4A-4D show two user devices (e.g., the first user device 402 and the second user device 403), mixed reality collaboration between more than two user devices is possible.

Referring to FIG. 4A, a second user may interact with a second user device 403, running an application, such as the collaboration application to register (404) with the platform 401. During registration, the second user device 403 can send registration information to the platform 401, such as a user identifier (e.g., user2) and user device information. The platform 401 can receive the registration information and store the registration information in a data resource (406), such as data resource 135 described in FIG. 1. The registration information can be stored in the data resource as part of registered user information.

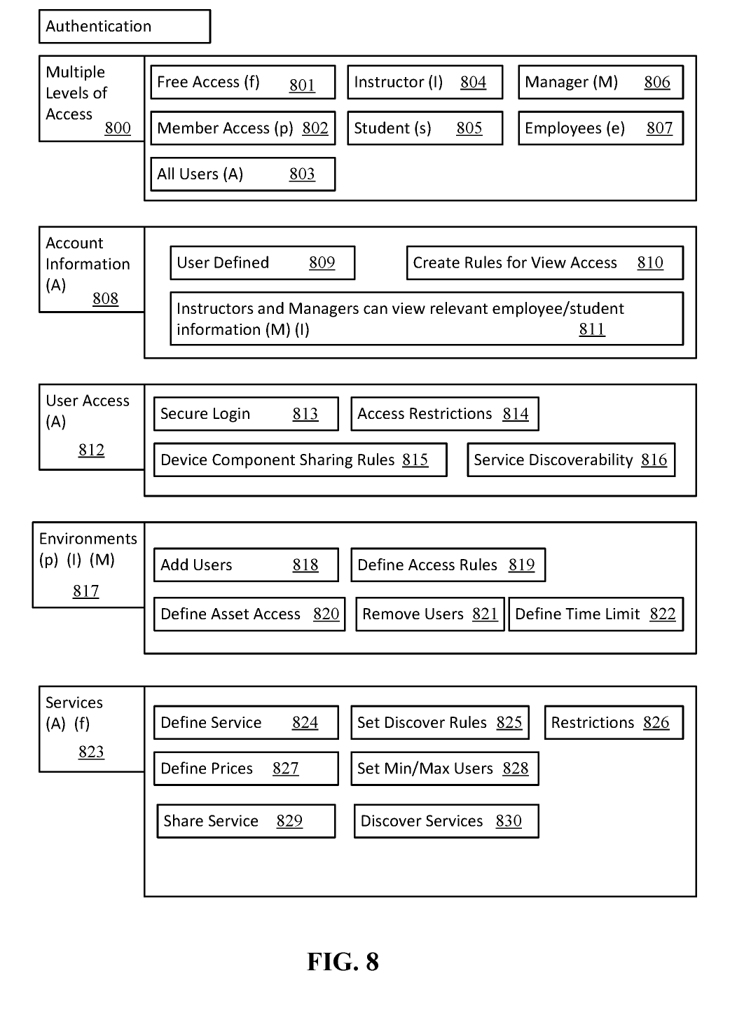

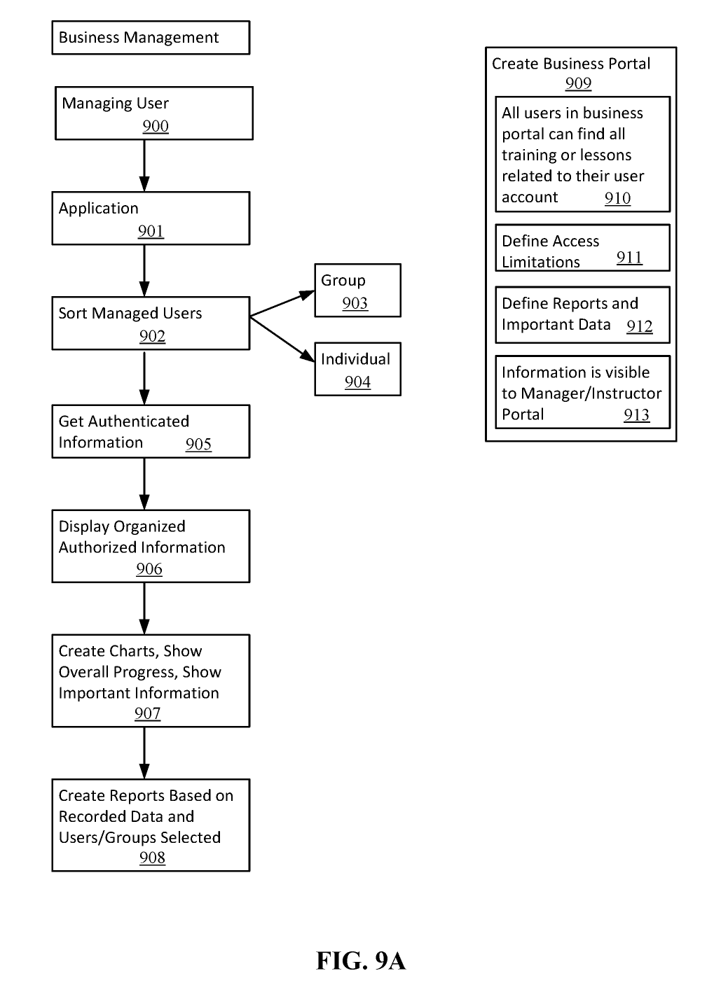

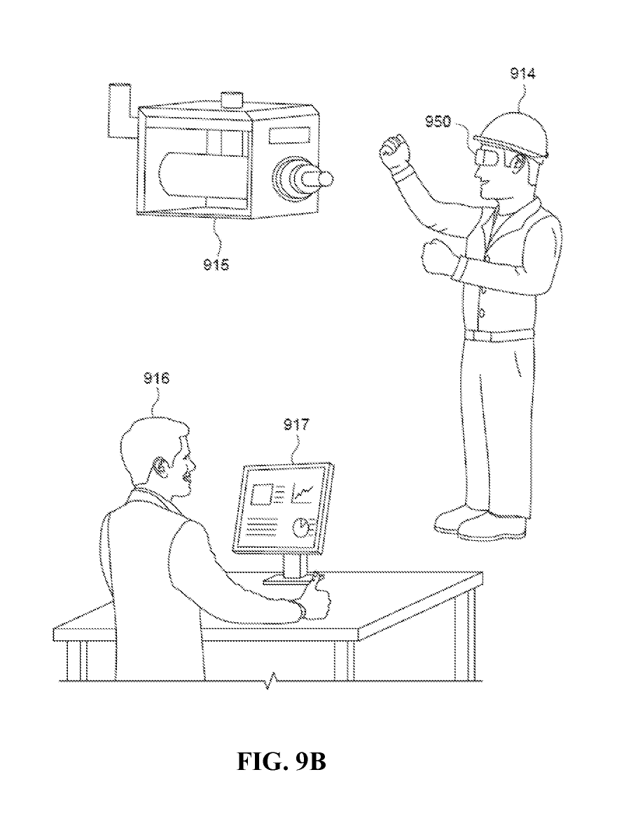

The second user may be, for example, a business supervisor, education instructor, or an event coordinator. When the second user registers with the platform 401, the second user can then be listed as having an available model in an application library. This can support the scenarios described in FIG. 8, FIGS. 9A and 9B, FIG. 13, FIGS. 16A and 16B, FIGS. 17A and 17B, and FIGS. 18A and 18B. The second user device 403 may register with the platform 401 at any time during process 400. Further, the registration information may be updated at any time. For example, the second user may register with the platform 401 while using one type of user device. However, the second user may use a different user device when the second user participates in a collaboration session. When the collaboration session is created, the second user device 403 can then send the platform 401 updated information, such as registration information, including the device information.

A first user may interact with a first user device 401 running an application, such as the collaboration application to register (408) with the platform 401. During registration, the first user device 402 can send registration information to the platform 401, such as a user identifier (e.g., user1) and user device information. The platform 401 can receive the registration information and store the registration information in the data resource (410). The registration information can be stored in the data resource as part of registered user information.

The platform 401 can then send the first user device 402 a manifest of the application library (412). In some cases, the manifest may include all applications and models in the library. In other cases, the manifest may include only the applications and models available to the first user. The first user device 402 can then receive the manifest (414) and display available applications and models (416) to the first user. In some cases, the first user device 402 may not register with the platform (408) until after the platform 401 sends the manifest of the application library (412).

The first user device 402 can receive a selection (418) from the first user and send that first user selection (420) to the platform 401. When the platform 401 receives the first user selection (422), the process 400 may continue to either step 424 or step 430, depending on the selection of the first user.

Referring to FIG. 4B, in the case where the first user selection is for a non-real-time model, the process 400 can continue to step 424. For example, the first user may select to run a non-real-time business training model or a non-real-time education model. In this case, the platform 401 can send the stored model (424) to the first user device 402. When the first user device 402 receives the model data (426), the first user device 402 can execute the model (428).

The non-real-time models can be created by 3D modeling software and saved to a data resource (e.g., data resource 135 described in FIG. 1) where the non-real-time model can be accessed by the users at any time. The non-real-time model can be hosted and available to download and use offline, or connect to and receive online sessions. The non-real-time model can be converted by the API into all supported operating systems before storage in the data resource, and the operating system version needed is seen by the collaboration application. Thus, the user only sees what is relevant to them.

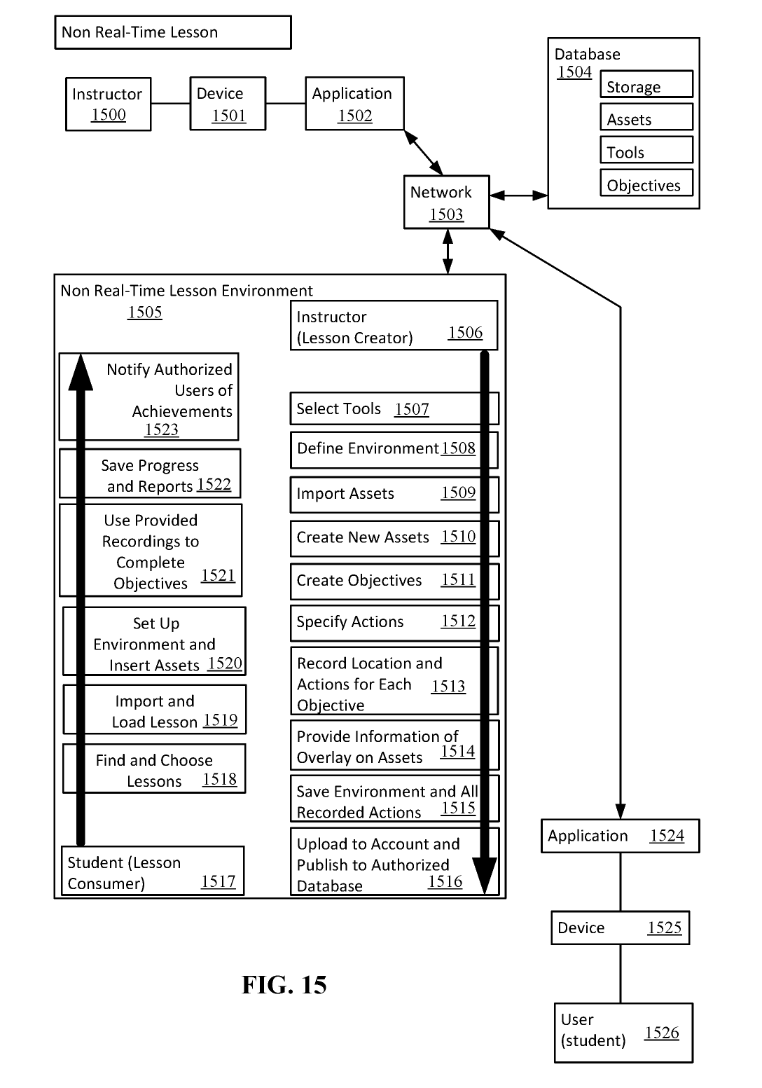

In some cases, communication is between the first user device 402 and the platform 401 for non-real-time model usage. During the non-real-time model usage, the usage data can be sent to the platform 401 and stored for later continuance of the non-real-time model. The usage data can include, for example, notes or progress of the user. In some cases, progress can be sent constantly or at specific milestones. This can support the scenario described in FIG. 15.

Referring to FIG. 4C, in the case where the first user selection is a selection for a real-time model, the process 400 can continue to step 430. For example, the first user may select to join a real-time model, such as an on-demand training, a live event, or an interview. In this case, the platform 401 can initiate communication (430) with the selected model provider (e.g., the second user) by sending a request to establish a connection. The second user device 403 can receive (432) the request to establish the connection and initiate a link (434) to the platform 401.

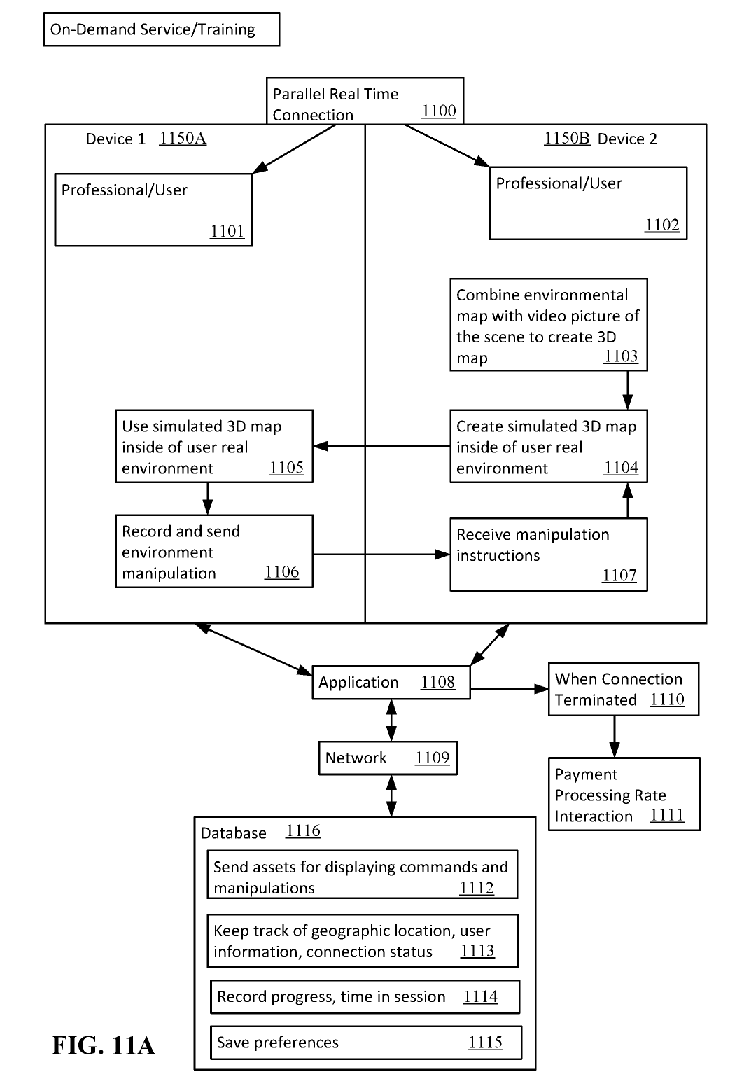

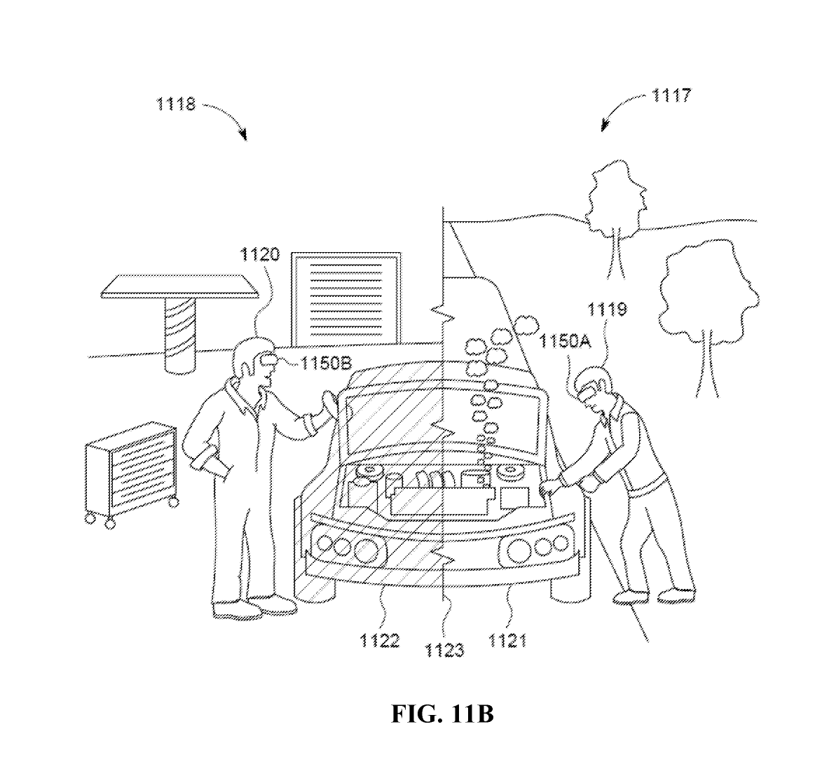

The platform 401 can then create a collaboration session (436) for the first user device 402 and the second user device 403. The platform 401 can link the first user device 402 (438) and the second user device 403 (440) to the collaboration session. Once the first user device 402 is linked to the collaboration session (438), the first user device 402 may begin communication (442). Similarly, once the second user device 403 is linked to the collaboration session (440), the second user device 403 may begin communication (444). This can support the scenarios described in FIGS. 11A and 11B, FIG. 12, and FIG. 14.

Referring to FIG. 4D, during a collaboration session, the platform 401 can facilitate communication between the first user device 402 and the second user device 403. The platform 401 can combine user video with environment mapping to create virtual environments that are shared between the users. The second user device 403 (e.g., the model provider) can create a simulated 3D map (446). The simulated 3D map can be a virtually created map of the environment of the second user. For example, in the case of an interview model, the second user would be the interviewer. The second user device 403 could map the room the interviewer is in, map the interviewer themselves, as well as record a video of the room. The second user device 403 can send (448) this 3D map data to the platform 401. The 3D map data sent by the second user device 403 will be in a format compatible with the operating system of the second user device 403.

When the platform 401 receives (450) the 3D map data from the second user device 403, the platform 401 can determine if a conversion is necessary (452) by determining if the format of the 3D map data is in a format compatible with the first user device 402. The platform 401 can determine if the conversion is necessary a variety of ways. For example, the platform 401 can compare the device information for the second user device 403 with the device information of the other user devices included in the collaboration session (e.g., the first user device 402). In some cases, the platform 401 can access the registered user information to determine the device information for each of the devices.

If the user device information is not the same for the second user device 403 and the first user device 402, or the format of the 3D map data is not in a format compatible with the first user device 402, then a conversion may be necessary. The platform 401 can convert (454) the 3D map data to a format that is compatible with the first user device 402. The platform 401 can access the supported device information stored in the data resource to identify the correct API calls corresponding to the device information (e.g., operating system) of the first user device 402. The platform 401 can send the 3D map data (456) to the first user device 402 according to the identified API calls of the first user device 402. Therefore, when the first user device 402 receives the 3D map data (458), the 3D map data will be in a format compatible with the operating system of the first user device 402.

If the user device information is the same for the second user device 403 and the first user device 402, or the format of the 3D map data is in a format compatible with the first user device 402, then the conversion may not be necessary. In this case, the API calls of the first user device 402 can be the same as the API calls for the second user device 403. The platform 401 can send the 3D map data (456) to the first user device 402 according to the identified API calls of the first user device 402. Therefore, when the first user device 402 receives the 3D map data (458), the 3D map data will be in a format compatible with the operating system of the first user device 402.

The first user device 402 can then display the 3D map (460) on the first user device 402. When the first user device 402 displays the 3D map (460), the first user can see a generated 3D rendition of the room the second user is in, as well as a generated 3D rendition the second user.

In some cases, the first user device 402 can send a simulated 3D map of the environment associated with the first user to the platform 401. For example, in the case of the interview, the first user would be the interviewee and the first user device 402 could map the first user to send to the virtual environment of the interviewer. The interviewer could then see a generated 3D rendition of the interviewee within the interviewer's virtual environment.

The first user device 402 can record a manipulation made within the virtual environment (462) by the first user and send the first user manipulation data to the platform 401 (464). The first user manipulation data may include data for any manipulation made by the first user, such as a manipulation of the first user, a manipulation of an item in the virtual environment, or a manipulation of an asset. Returning to the interview example, the first user (e.g., interviewee) manipulation could be the first user sitting down in a chair or handing their resume to the second user (e.g., interviewer). The first user manipulation data sent by the first user device 402 will be in a format compatible with the operating system of the first user device 402.

The platform 401 can receive the first user manipulation data (466) from the first user device 402. The platform 401 can determine if a conversion is necessary (468) by determining if the format of the first user manipulation data is in a format compatible with the second user device 403. The platform 401 can determine if the conversion is necessary a variety of ways. For example, the platform 401 can compare the device information for the first user device 402 with the device information of the other user devices included in the collaboration session (e.g., the second user device 403). In some cases, the platform 401 can access the registered user information to determine the device information for each of the devices.

If the user device information is not the same for the second user device 403 and the first user device 402, or the format of the first user manipulation data is not in a format compatible with the second user device 403, then a conversion may be necessary. The platform 401 can convert (470) the first user manipulation to a format that is compatible with the second user device 403. The platform 401 can access the supported device information stored in the data resource to identify the correct API calls corresponding to the device information (e.g., the operating system) of the second user device 403. The platform 401 can send the first user manipulation data (472) to the second user device 403 according to the identified API calls of the second user device 403. Therefore, when the second user device 403 receives the first user manipulation data (474), the first user manipulation data will be in a format compatible with the operating system of the second user device 403.

The second user device 403 can then display the first user manipulation data (476) on the second user device 403. When the second user device 403 displays the first user manipulation data (476), the second user can see a generated 3D rendition of the first user, as well as the manipulation the first user made.

The second user device 403 can record a manipulation made within the virtual environment (478) by the second user and send the second user manipulation data to the platform 401 (480). The second user manipulation data may include data for any manipulation made by the second user, such as a manipulation of the second user, a manipulation of an item in the virtual environment, or a manipulation of an asset. Returning to the interview example, the second user (e.g., interviewer) manipulation could be the second user sitting down in a chair at their desk or picking up the first user's (e.g., interviewee) resume. The second user manipulation data sent by the second user device 403 will be in a format compatible with the operating system of the second user device 403.

The platform 401 can receive the second user manipulation data (482) from the second user device 403. The platform 401 can determine if a conversion is necessary (484) by determining if the format of the second user manipulation data is in a format compatible with the first user device 402. The platform 401 can determine if the conversion is necessary a variety of ways. For example, the platform 401 can compare the device information for the second user device 403 with the device information of the other user devices included in the collaboration session (e.g., the first user device 402). In some cases, the platform 401 can access the registered user information to determine the device information for each of the devices.

If the user device information is not the same for the second user device 403 and the first user device 402, or the format of the second user manipulation data is not in a format compatible with the first user device 402, then a conversion may be necessary. The platform 401 can convert (486) the first user manipulation to a format that is compatible with the first user device 402. The platform 401 can access the supported device information stored in the data resource to identify the correct API calls corresponding to the device information (e.g., the operating system) of the first user device 402. The platform 401 can send the second user manipulation data (488) to the first user device 402 according to the identified API calls of the first user device 402. Therefore, when the first user device 402 receives the second user manipulation data (490), the second user manipulation data will be in a format compatible with the operating system of the first user device 402.

The first user device 402 can then display the second user manipulation data (492) on the first user device 402. When the first user device 402 displays the second user manipulation data (492), the first user can see a generated 3D rendition of the virtual environment, as well as the manipulation the second user made.

The following example scenarios may be implemented using the above-described platform and services.

### EXAMPLE SCENARIOS

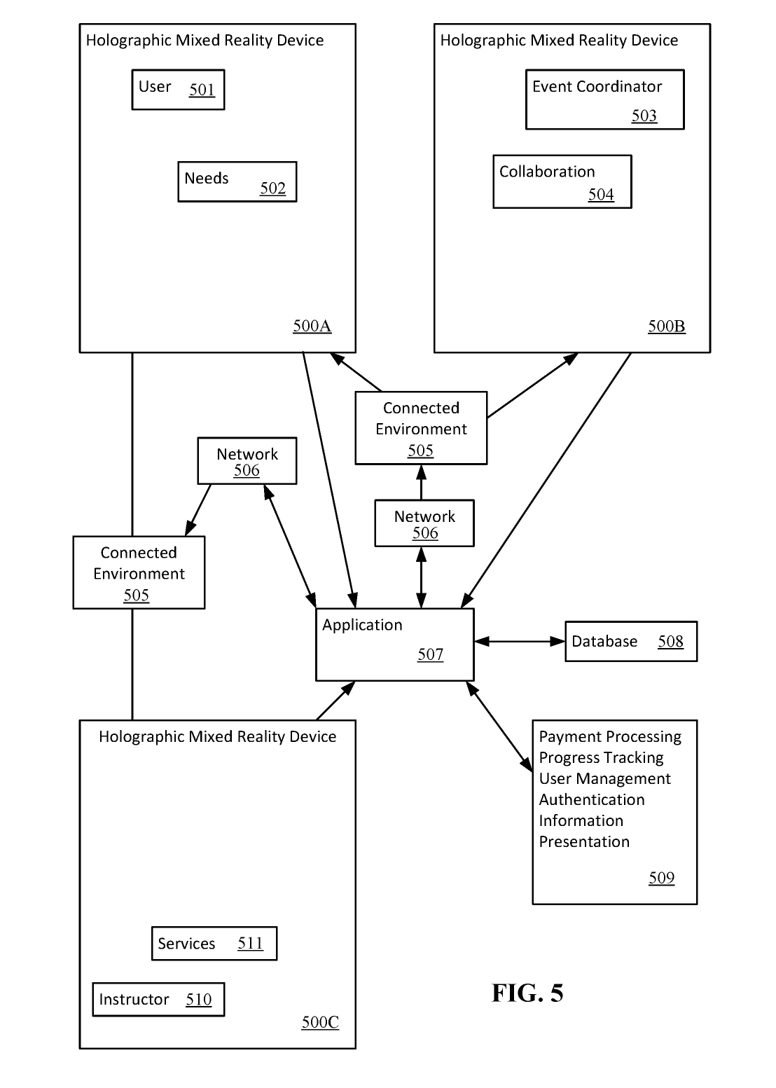

FIG. 5 illustrates a conceptual scenario in which various embodiments of the invention may be practiced. Referring to FIG. 5, by using a mixed reality device 500 (such as mixed reality device 500A), a user 501 with defined needs 502 expressed or implied can use the application 507 to locate services on the network 506 and join a cloud-based collaborative environment 505 with which they will interact with other users and remain connected until they terminate their session. During the connection, the application 507 will use mixed reality device input to record and send session information to users, and save progress, assets and inputs to a database 508 for later use. The application 507 keeps track of many of the cloud-based functions 509, as well as translating data received from other user devices. Authentication and discovery can happen before a connection is made. During a connection, the application 507 uses the connection platform to start and manage the connection, send and receive device information, and display that information effectively to the user. After a connection is terminated, the connection information is saved to a server and accessible by the users who were in the session, progress management is possible from the application 507, and payments are processed securely through a secure process. Event coordinators 503 and Instructors 510 use the same mixed reality devices 500 (such as mixed reality device 500B and mixed reality device 500C) to manipulate the application 507 and collaboration environments 504 or services 511 over the network 506 and publish the service or environment to the server database 508 to be compiled and presented to users via the underlying connection platform. The network 506, in this case, is any collection of connected computing devices capable of sending and receiving information by LAN or wireless LAN services, broadband cell tower 4G or LTE service, or any broadband remote connection. The cloud server manages the connection platform, stores information, and keeps track of user data and service data. All collaborative sessions are created and managed on the server, here forth referred to as the database. The database is a collection of events, assets (user created and application created), times, progress, tools, and preferences.

FIG. 6 illustrates an example scenario of mixed reality collaboration. Referring to FIG. 6, the user can engage in the application to utilize the platform for finding relevant information and discovering services to connect to using the connection platform. The application 600 itself is software that sits on top of a device and interacts with the hardware of the device to record information, communicate with the server, and establish connections to remote users. First, the user puts on a device and accesses the application 600. Then, they are presented with view portals 612 that allow them to sort information based on types of services or features or groups. Some examples of different portals would be services 613 like mechanics or nurses, training 614 for a skill or toward a certification, events 615 to view, education 616 for students or teachers that are part of a school or university, business 617 for users that are part of an organization, collaborative sessions 619 which are user defined and based on topics or categories for group communication, management 620 for accessing reports or planning goals and objectives to be learned, statistics 621 for looking at the users progress and comparing it to stats of other users, User settings 622 for changing authorized access level and other user-specific information, or any other 618 user defined portal combining sorted information and data available on the database. After a portal is selected 624, information is presented to the user in 3D or optionally in 2D view space in an organized fashion 625. The user is presented search options to find services or lessons to connect to, and select the courses to view more information 626. The detailed information is displayed 627 along with connection info and criteria, price if applicable, ratings and any other information 629 relevant to the user. The creator 628 is also displayed with information about them. If the user decides to continue with this choice and attempt to connect 630 a connection is facilitated between user and provider. After the session has run the course, and the user is no longer engaged in the material for the connection, they terminate 631 their connection to the server. At termination 632 the fee is processed 633, all data is saved for completion or non-completion 634, the session information is saved 635, the user rates the experience or course 636 and exits the live session 637. While connected to a session, the application saves progress at certain milestones or tasks. At 601 the process is overviewed, as each objective is completed 602 the application checks to see if there are more objectives 603 to which it will either find another one and loop 604 or continue 606 to the goals 607. The goal is a collection of objectives, to which the new set of objectives will loop 605 if there are new objectives 608 until all objectives in a goal are complete 609 which leads to the completion of the course 610. At each objective, goal and completion stage, progress is recorded 611 and saved to the server. Objectives can be any defined event that a user may want to review or repeat at a later time in a different session of the same service or lesson.

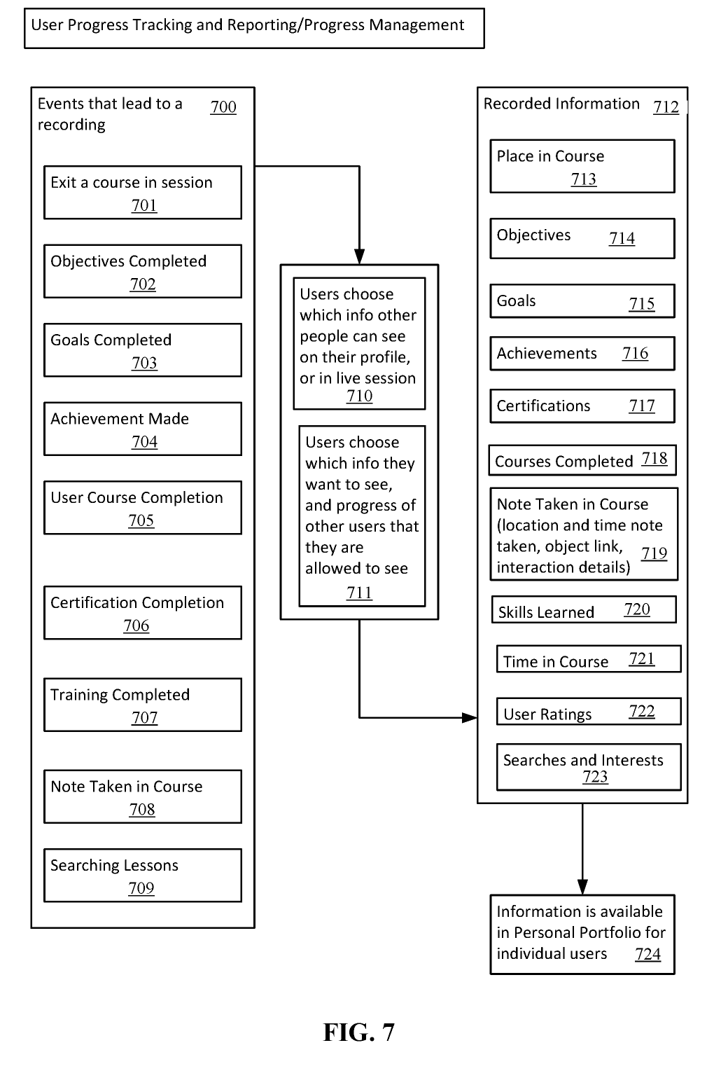

FIG. 7 illustrates an example scenario of mixed reality collaboration with progress tracking. Referring to FIG. 7, events may be recorded for the creation of content and report generation referred to by 611, as described in FIG. 6. Events that lead to a recording 700 generate data that can be used 712 to create reports, review past usage, and share information about success. These events include exiting a course 701, completing a predefined objective 702, completing a predefined goal 703, performing an achievement in the app 704, completing a course in its entirety 705, gaining a certification 706, completing a training or receiving a grade for performance 707, taking a note inside of the course 708, or searching for services/courses 709, and any other event that a user may or may not want to record. Users choose dynamically and predefined information that they do and do not want to share with other users, as well as what type of user may see certain types of information 710. They can also define what type of information they want to see from other users, and will see that information if they have been allowed access by the remote user 711. Users can then use a plurality of information saved in the database to create reports and repeat certain courses, establish new connections with previously located individuals or providers that they saved, or groups with which they have joined 712, 713-723. Additionally, information would be viewable in the personal portal for individuals and accessible to authorized users in administrative portals or report portals 724.

FIG. 8 illustrates example scenarios of access restriction for mixed reality collaboration. There can be many levels of access restriction. It should not be assumed that this is all inclusive, however, all information will be classified into categories and given access types that can be user defined or application defined. The levels of access 800 begin with defining access structures by user type. For example, free users 801 have different automatic privilege levels than members 802, and general member access has different inherent groups that instructors 804, managers 806 and students 805. Students could access certain lessons and materials specific to the school they have been authorized to view information from, assuming they are part of that organization, which the instructor 804 has access to the student's information as defined by the institution they are part of 808. Managers 806 can easily see employee 807 information like course completion and create reports based on that data 811, however, there are some restrictions that no user may view, like credit card information or proof of entity type, and user-defined access 808 that allows users to limit what information they automatically share 809, and with whom they share that data 810.

All users 803 have the user access 812 ability to log in securely 813, discover services 816, share their device information 815 that is automatically recorded upon configuration, and managing entities can create access rights 814 to their content. In fact, any user that creates a collaboration environment 817 is able to manage access 818, 821 to that environment and define specifications 819, 820, 822 for users to find and discover the session through the platform. The majority of users are able to use and create services 823 through which they have proven to be a professional in the field. Users define their services 824, set rules on discovering the service 825, restrictions for use 826, define prices 827, set minimum and maximum users 828, share services 829, or discover 830 and browse services created on the platform. Other functions for authentication will also be possible and dynamically added as users' needs are further defined, including, but not limited to, restricting content to certain users within the same environments dynamically, or providing temporary access to assets, data or user information not previously allowed or stated.

FIGS. 9A and 9B illustrate example scenarios of mixed reality collaboration for business management. Management can be provided to the individual user, and for administrative users like business supervisors and instructors who will have a leader role and manage multiple users. For the individual, there is a personal portal, such as 724, as described in FIG. 7, where users may track their progress and manage their learning plans or track services and lessons used, or groups and professionals they have saved. Referring to FIG. 9A, the business or Institution creates a portal 909 for their employees or students. All users defined in the group for that business or institution or instructor can find the lessons or training sessions in their respective portal 910, and access can be added or denied per user 911 and per course. Managing users have the option to define information used in reports 912 and can see this information in their business portal 913. The managing user 900 uses the application 901 to pull relevant data and sort users 902 into groups 903 or look at one user for which they manage at a time 904. They look at data that is authorized for them to view in those groups 905 and it is displayed 906 to them on the application through the mixed reality viewing device. Using that data, they can create charts, graphs, and other manipulation capable table-like data 907 to show progress and success of managed users 908.

Referring to FIG. 9B, a managing user 916 can view a report and data 917 on an individual 914 that is using a mixed reality heads-up display 950 to perform non-real-time lessons 915; the lessons of which are being tracked for the reporting.

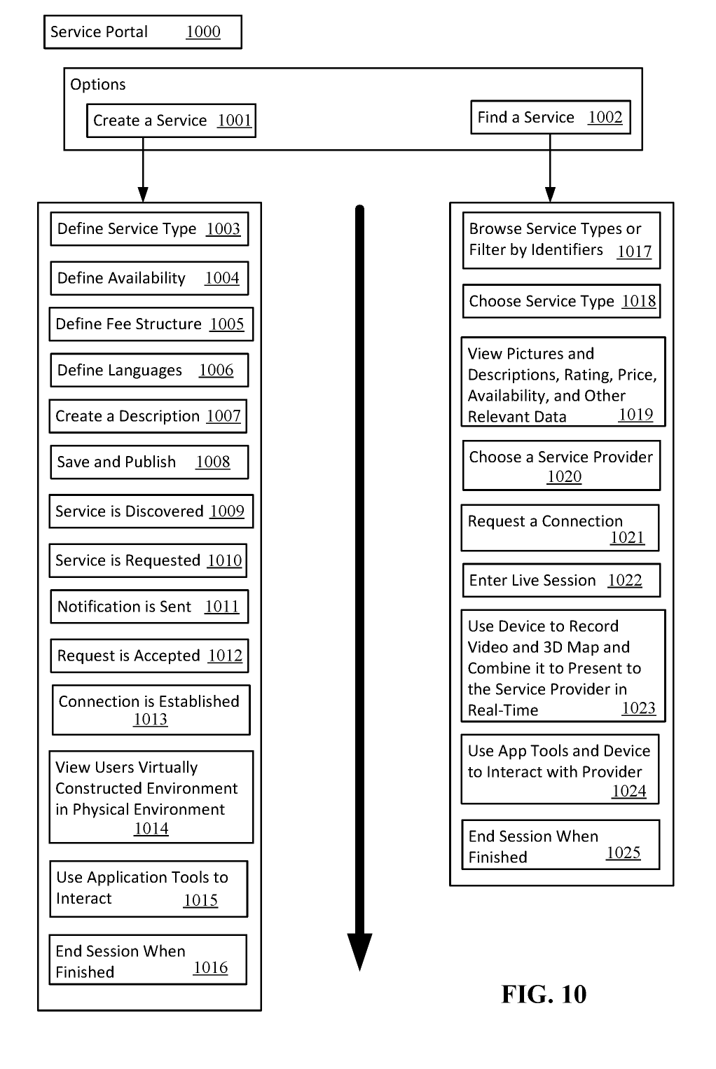

FIG. 10 illustrates an example scenario for providing mixed reality collaboration. Referring to FIG. 10, an example of a generic portal may be a service portal 1000, for discovering services based on customer needs, for on-demand connections to those professionals. Users that have a service to perform can create a service model 1001 and define criteria for the service model, such as the service type, availability, fee structure, languages, and description, as shown in 1003-1016. The service provider publishes this service, which will then be discoverable by a user during the times in which the provider is available. Users have different options, for example their options cater more toward finding and browsing services 1002 and getting more information about the service that was published, and choosing whether or not to connect to the service provider, as shown in 1017-1025.

FIGS. 11A and 11B illustrate example scenarios of mixed reality collaboration for on-demand service/training. Referring to FIG. 11A, a parallel real-time connection 1100 of an on-demand service can be facilitated where two people connect 1101, 1102 and share their device recorded information. The user's device 1150A combines the environmental map with video picture rendering of the scene to create a 3D map for manipulating 1103. The device 1150A then creates the virtual environment 1104 to send to the other user, who receives the map and is shown the virtual environment inside of their own environment 1105 on their device 1150B. That user then makes manipulations in the virtual environment 1106 that is sent back to the originating user to show interactions to their physical environment 1107 which are visually displayed for them. Not discussed in detail, but also found in FIG. 11A, are 1108-1115.

Referring to FIG. 11B, on the right 1117 the user 1119 experiences car 1121 issues. The user 1119 puts on his mixed reality head mounted display 1150A and connects to a professional using the application and platform. That professional 1120 picks up their mixed reality head mounted display 1150B and can now see a virtually recreated car 1122 and where 1119 is in relation to the environment, while being in a separate physical environment 1118. The professional 1120 points or touches parts of his virtually represented world from 1119 and the manipulations are then visible by 1119 while he interacts with the physical world in real-time being guided through the work. Line 1123 shows a separation of geographic location, as well as a virtual boundary where two people in separate locations seemingly fuse together to see the same environment.

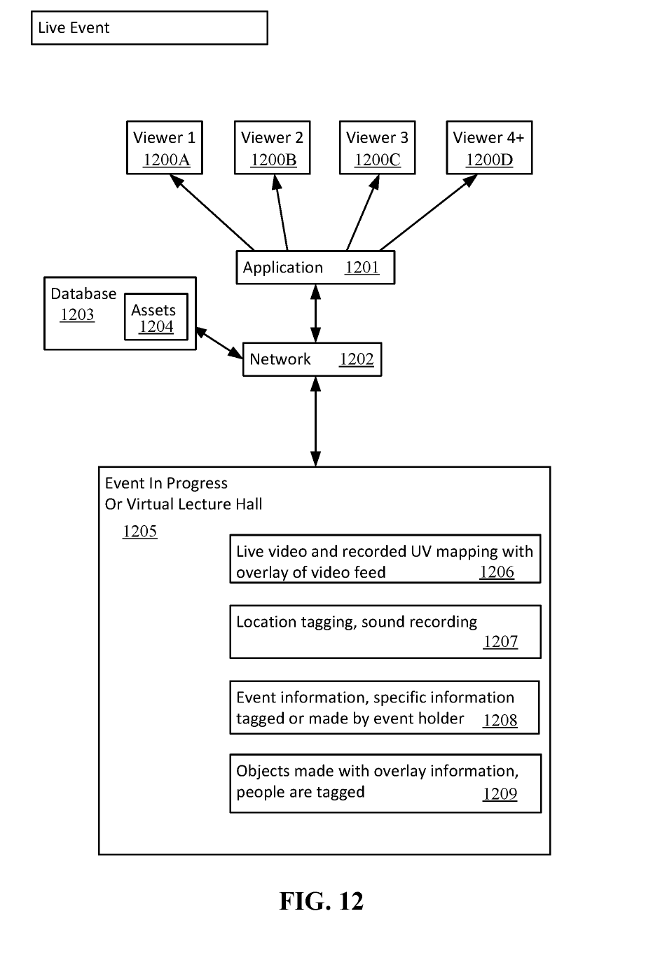

FIG. 12 illustrates an example scenario of mixed reality collaboration for a live event. Referring to FIG. 12, a live event may be communicated to multiple users. There are multiple users 1200A-1200D viewing the event, which would have connected through our platform 1201. The event is then broadcast to the people connected, and does not take inputs from the users, aside from any conditions the event would like to allow users to interact with, like changing location or viewing data overlays when looking at certain objects and assets 1206-1209.

In FIG. 12, a live video can also be recorded with UV mapping overlay. For example, the device can going to track where a person is and what is around them and re-create the scene to be transmitted to the platform to be broadcast to other users or people who are viewing this event. The location tagging can include where a person is when they are recording the video; and a sound recording can include any device recording that is possible (such as sound, video, and geographic location. The recordings may depend on the capabilities of the device. The device can record the data and send it to the platform to be given to the users so that event information can be displayed. 1208 describes if the person recording and transmitting this event indicates parts of the created world, they can mark them so they are viewable to the end user.

For example, if a user is at a football field, watching football and recording the game in virtual reality, they can transmit the data to the platform, which is then giving that data to the other people so that the users can feel like they are at the game. The user sending the data can, for example, tag a section of the field and make an icon on it and talk about it, all while the other users are receiving that icon and seeing it in the virtually created mapping of the environment.

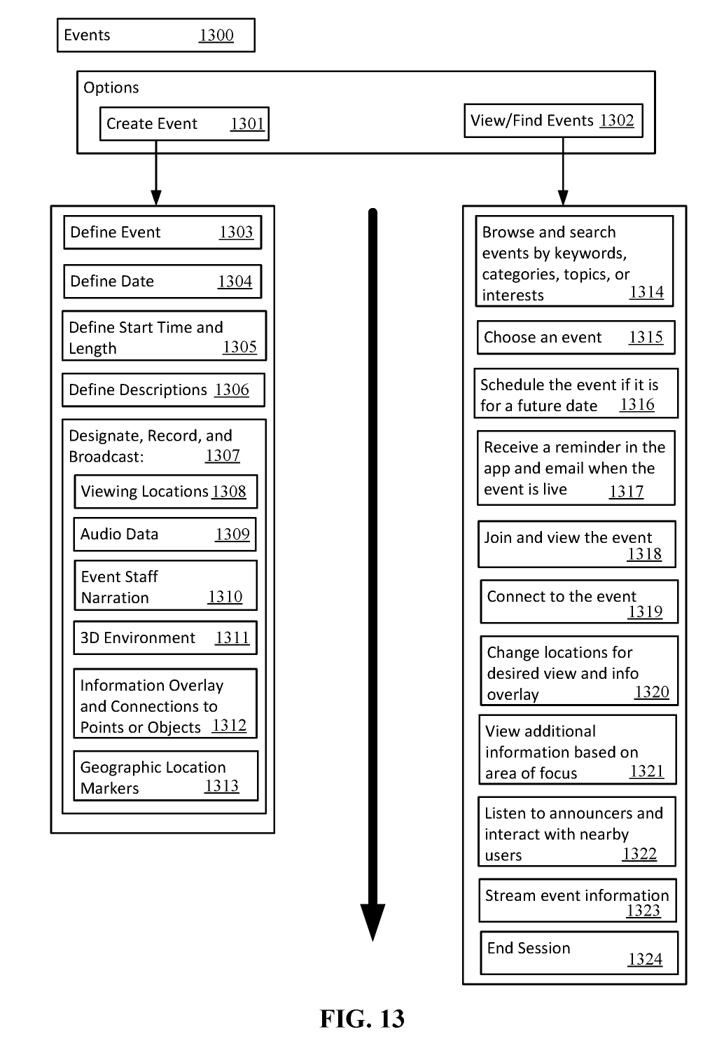

Not discussed in detail, but also found in FIG. 12, are 1202-1204. A more detailed discussion of a live event will be presented in FIG. 13.

FIG. 13 illustrates an example scenario of mixed reality collaboration for events. Referring to FIG. 13, options for creating and managing 1301 events 1300 are provided, as well as viewing and scheduling options 1302 for events 1300. Creating and managing events 1301 may be performed by one or more of 1303-1313. Viewing and scheduling events 1302 may be performed by one or more of 1314-1324.

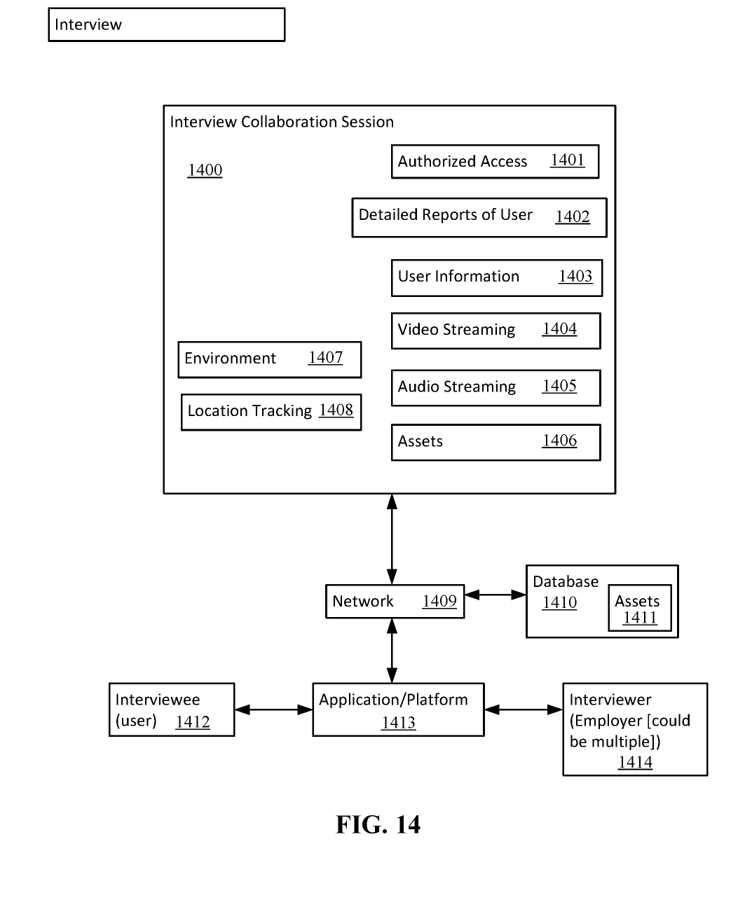

FIG. 14 illustrates an example scenario of mixed reality collaboration for an interview. Referring to FIG. 14, a collaborative interview session 1400 may be facilitated where an interviewee 1412 and an interviewer 1414 connect through the platform 1413 to establish a connection between them and be in the persistent environment created by the interviewer 1414. They have access to all tools and data from the application, shown in 1401-1408 and it is available online and instantly. Not discussed in detail, but also found in FIG. 14, are 1409-1411.

FIG. 15 illustrates an example scenario for a non-real-time session. Referring to FIG. 15, a non-real-time lesson may be facilitated. breaks down A user 1506 can create a non-real-time lesson that would be published to the server on the cloud, and accessible anywhere for the consumer of the lesson 517. 1507-1516 show the process the creator goes through, and 1518-1523 show the process the consumer goes through. Not discussed in detail, but also found in FIG. 15, are 1500-1504 and 1524-1526.

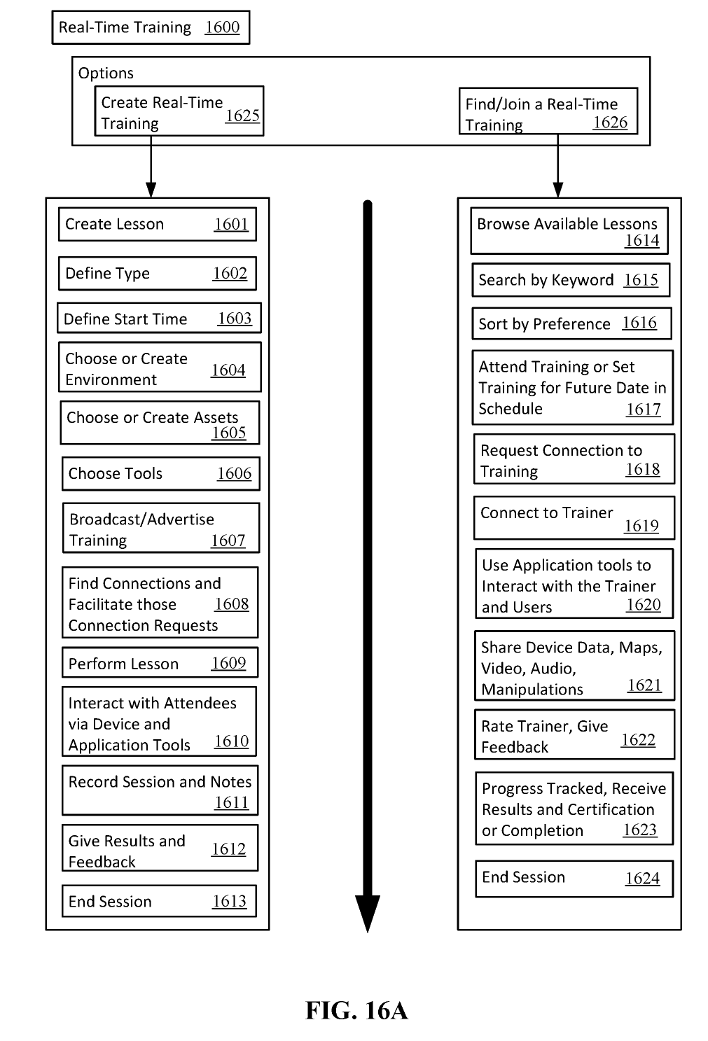

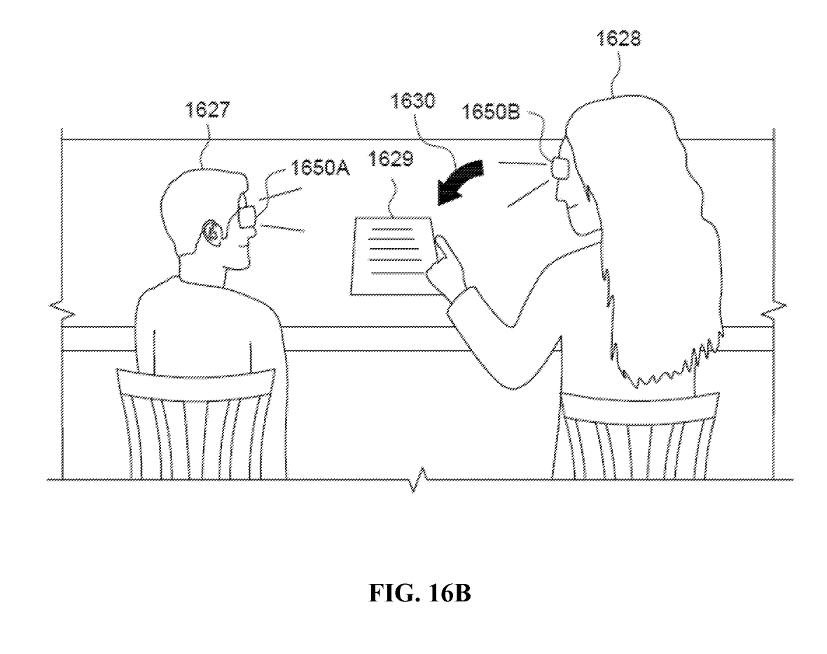

FIGS. 16A and 16B illustrate example scenarios of mixed reality collaboration for real-time training. Referring to FIG. 16A, options given for creating 1625 or discovering 1626 services in real-time training 1600 portals in the application are provided. 1601-1613 is a general process a user would take to create content and communicate lessons with the users who connect to them, as well as sharing and publishing content. 1614-1624 are the options most users would have when finding and joining real-time lessons. Ending a session 1624 can begin the process 632, as defined in FIG. 6.

Referring to FIG. 16B, a representation of the real-time training in action is provided. A tutor 1628 explains a paper 1629 that the student 1627 has at his house and is being virtually transmitted via device 1650A from student 1627 to 1650B while 1628 makes manipulations 1630 that are visible to 1627.

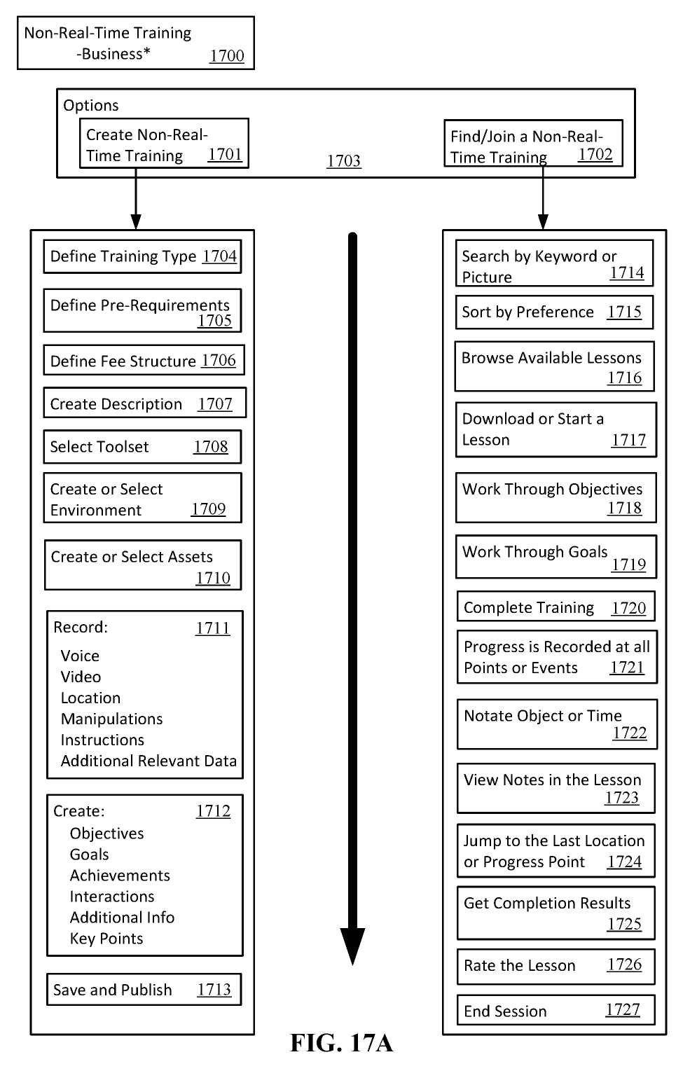

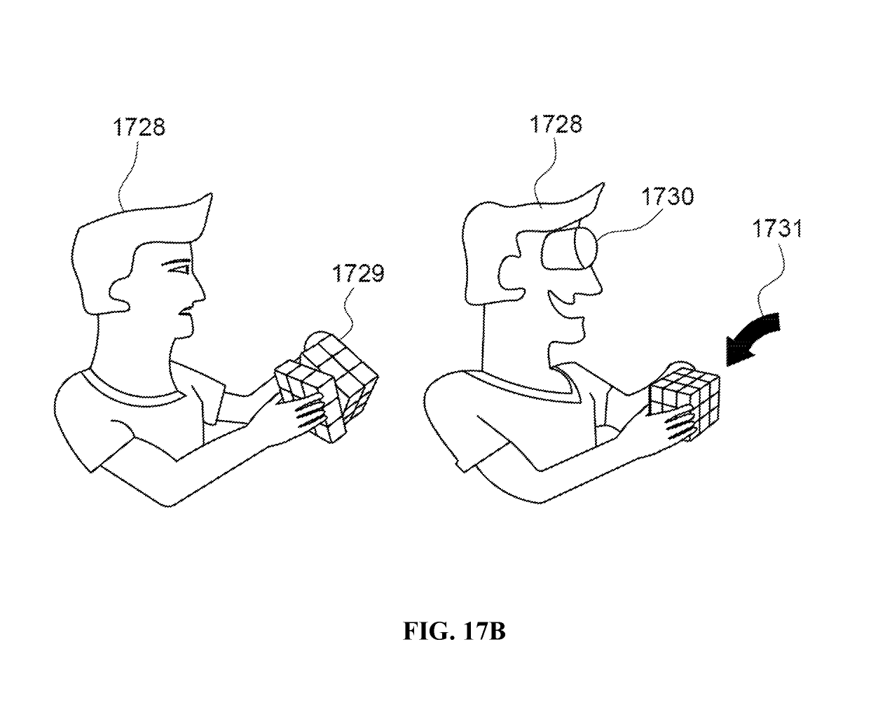

FIGS. 17A and 17B illustrate example scenarios for non-real-time training. Referring to FIG. 17A, additional options for non-real-time training lessons 1700 creation 1701 and consumption 1702 are provided. The recording 1711 and creation of events 1712 that are followed by the user 1718-1721 are shown. Not discussed in detail, but also found in FIG. 17, are 1704-1710, 1713-1717, and 1722-1727.

Referring to FIG. 17B, a visual representation of an embodiment includes a user 1728 finding an instruction manual for a Rubik's cube 1729 using his display device 1730 and using the prerecorded lesson to guide himself through solving it at 1731.

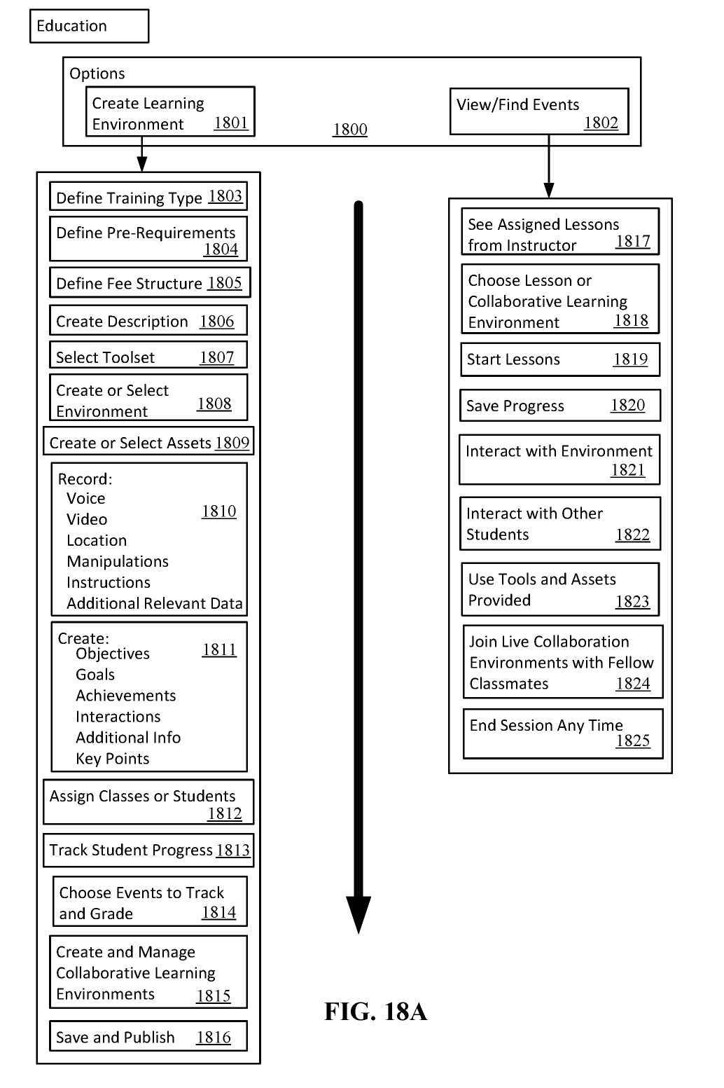

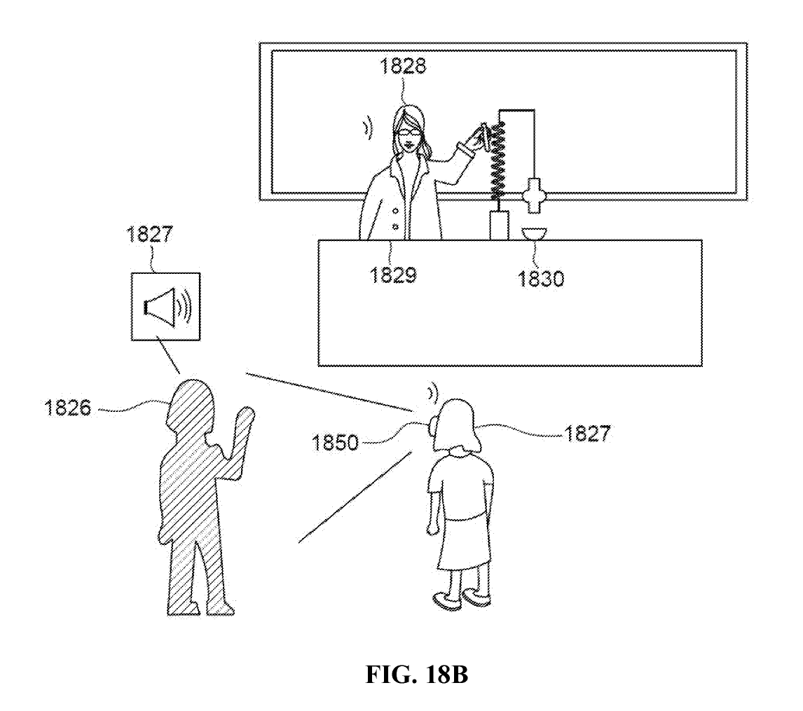

FIGS. 18A and 18B illustrate example scenarios for education. Referring to FIG. 18A, options for creating 1801 lesson and managing lessons and users 1803-1816 in education are provided. Users and students who have access to these lessons use options in 1817-1825 to find, view and interact with these lessons or environments that they have authorization for 1802.

Referring to FIG. 18B, a visual representation of this concept is shown, with a teacher 1829 showing a lesson 1828 and 1830 to a class inside of a virtual learning environment they have created, where students 1827 with a device 1850 can see other students and interact 1831 with them through the platform, when students connect through the platform 1826, inside of the environment.

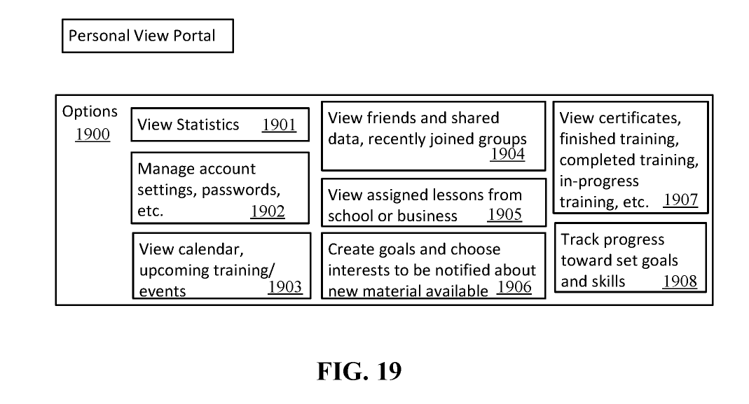

FIG. 19 illustrates an example scenario for a personal view portal. Referring to FIG. 19, collective options for personal account management viewing portal are provided. 1901-1908 are standard options, and more can be dynamically added for easing the use of the application and platform, and increasing connectivity and authentication rules.

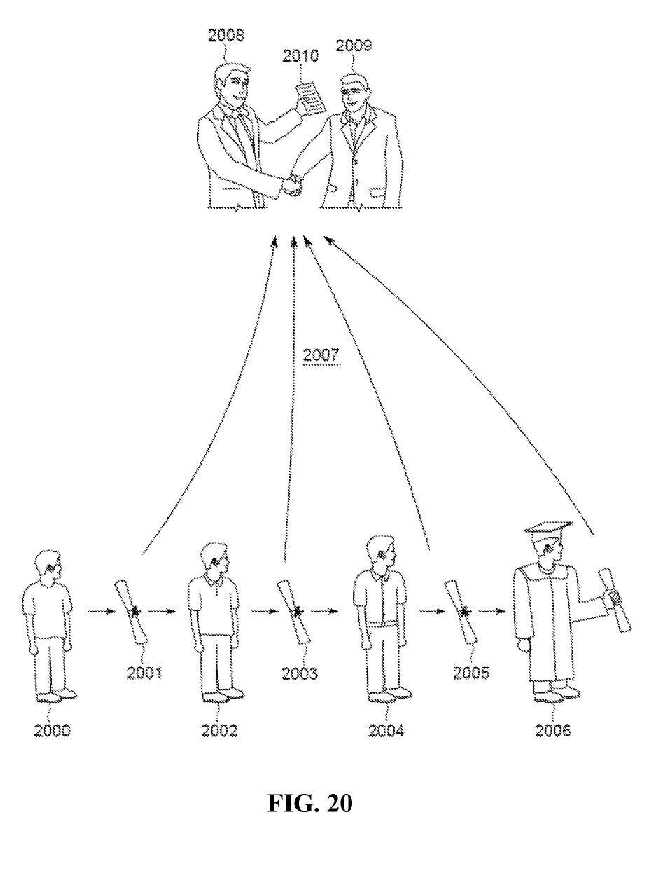

FIG. 20 illustrates a conceptual benefit of the platform. Referring to FIG. 20, a further example of how a user who has this connection platform can use his information and connections and take them 2007 with him from the beginning of school 2000 all the way to graduation 2006 (as shown in 2000-2006) and a successful career, and being able to share his 2008 credentials 2010 with other professionals 2009 is shown.

Further example scenarios include:

A cloud-based platform for managing connections between multiple users with mixed reality devices.

A method for cloud-based connection management between multiple users with mixed reality devices.

A cloud-based service for finding and sharing services and collaborative environments.

A cloud-based method for finding and sharing services and collaborative environments.

A method in which two or more users may create persistent virtual collaborative environments and define access to the environments.

A method in which two or more users may connect and interact with persistent virtual collaborative environments.

A method and platform for managing progress and user data using mixed reality devices and cloud-based servers.

A cloud-based connection platform built under a software designed for operation with virtual reality, augmented reality, and mixed reality head mounted displays where two or more people share and discovery services offered by other users. Users can interact with an application to establish a connection through a network that will leverage the recording devices of their headsets to create and share their physical environments and create and manipulate them through virtual environments made from a combination of 3D mapping and video overlay of the physical environment. In one case, this connection and the use of this platform can create a method for service providers to offer on-demand services to users in remote locations and allow their services to easily be discovered. Other cases can include connecting to user created environments for group chats in mixed reality collaborative environments, creating content for schools and businesses for real-time and non-real-time training with or without live instruction and a method for which authentication of environments and dynamic access restrictions for user generated content.

A connection platform that establishes a link between two different users and eases the access to the available services and discovering of those services using a plurality of devices, with a focus on the connection and sharing of environment being linked to mixed reality head mounted displays can be provided. A user attempting to discover a service and connect to a professional using plurality of viewing devices can find these providers quickly and efficiently using categories and keywords; filtering for relevant services, price points, ratings, easiness to work with, and more. The connection platform can be completely cloud-based, where the software links the viewing device and the database, connecting two users instantaneously and on-demand. When a user searches for a service, they choose a person or provider, request a connection and the software connects the two devices over the internet. A collaborative environment can be created with the devices and stored virtually on the internet. Information is securely shared between the two users with an established connection, and personal information is stored but never shared without user consent.

Service providers and users can create and advertise services to be discovered by all other users. These services include live real-time services or non-real-time services that are stored on cloud servers (in conjunction with persistent collaborative environments). When a user connects to the service provider or the non-real-time service, they are connected to the learning environment and share their device information, video recording, voice and actions in the physical environment as they relate to the virtual environment. Users and providers interact with one another or with pre-recorded content using tools provided by the application and platform. The interactions are saved and stored for later reviews. Progress is tracked by all users on any device. Payment is handled securely on the platform and network as well, and no personal protected information is given from one party to the other. Members have access to their own information and can manage their training paths. Business Supervisors and Education Instructors can create classes for assigning lessons to users in groups, access and managing their progress, and providing collaborative environments with shared content that is easily accessible to each user in the groups. Event coordinators can create and share events that users can view and browse (and subsequently connect), or save for a later time when the event is live. Collaboration environments combine user video with environment mapping to create virtual environments that are shared between users, and these virtual environments are found by joining groups, browsing in the platform from their mixed reality device, and being offered the connections based on user history and needs. An application library is created to be explored and utilized by all users.

FIG. 21 illustrates an example computing system that can implement a mixed reality device. As shown in FIG. 21, computing system 2100 can implement a holographic enabled device. Computing system 2100 includes a processing system 2102, which can include a logic processor (and may even include multiple processors of same or different types), and a storage system 2104, which can include volatile and non-volatile memory.

Processing system 2102 may include one or more physical processors (hardware) configured to execute software instructions. Additionally or alternatively, the logic processor may include one or more hardware logic circuits or firmware devices configured to execute hardware-implemented logic or firmware instructions. Processors of the processing system 2102 may be single-core or multi-core, and the instructions executed thereon may be configured for sequential, parallel, and/or distributed processing. Individual components of the processing system 2102 optionally may be distributed among two or more separate devices, which may be remotely located and/or configured for coordinated processing. Aspects of the processing system 2102 may be virtualized and executed by remotely accessible, networked computing devices configured in a cloud-computing configuration. In such a case, these virtualized aspects are run on different physical logic processors of various different machines.

Processing system 2102 includes one or more physical devices configured to execute instructions. The processing system 2102 may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result. When the instructions are software based (as opposed to hardware-based such as implemented in a field programmable gate array (FPGA) or digital logic), the instructions can be stored as software 2105 in the storage system 2104. Software 2105 can include components for a mixed reality collaboration application as described herein.

Storage system 2104 may include physical devices that are removable and/or built-in. Storage system 2104 can include one or more volatile and non-volatile storage devices such as optical memory (e.g., CD, DVD, HD-DVD, Blu-Ray Disc, etc.), semiconductor memory (e.g., RAM, SRAM, DRAM, ROM, EPROM, EEPROM, FLASH memory, etc.), and/or magnetic memory (e.g., hard-disk drive, floppy-disk drive, tape drive, MRAM, etc.), or other mass storage device technology. Storage system 2104 may include dynamic, static, read/write, read-only, random-access, sequential-access, location-addressable, file-addressable, and/or content-addressable devices. It should be understood that a storage device or a storage medium of the storage system includes one or more physical devices and excludes transitory propagating signals per se. It can be appreciated that aspects of the aspects of the instructions described herein may be propagated by a pure signal (e.g., an electromagnetic signal, an optical signal, etc.) using a communications medium, as opposed to being stored on a storage device or medium. Furthermore, data and/or other forms of information pertaining to the present arrangement may be propagated by a pure signal.

Aspects of processing system 2102 and storage system 2104 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 2100 implemented to perform a particular function. In some cases, a module, program, or engine may be instantiated via processing system 2102 executing instructions held by a non-volatile storage of storage system 2104, using portions of a volatile storage of storage system 2104. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 2106 may be used to present a visual representation of data held by storage system 2104. This visual representation may take the form of a graphical user interface (GUI). As the herein described methods and processes change the data held by the storage system, and thus transform the state of the storage system, the state of display subsystem 2106 may likewise be transformed to visually represent changes in the underlying data. Display subsystem 2106 may include one or more display devices utilizing virtually any type of technology. Such display devices may be combined with processing system 2102 and/or storage system 2104 in a shared enclosure, or such display devices may be peripheral display devices. An at least partially see-through display of an HMD is one example of a display subsystem 2106.

When included, input subsystem 2108 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; any suitable sensor.

When included, network interface and subsystem 2112 may be configured to communicatively couple computing system 2100 with one or more other computing devices. Network interface and subsystem 2112 may include wired and/or wireless communication devices compatible with one or more different communication protocols. As non-limiting examples, the network interface and subsystem 2112 may be configured for communication via a wireless telephone network, or a wired or wireless, near-field, local- or wide-area network. In some embodiments, the network interface and subsystem 2112 may allow computing system 2100 to send and/or receive messages to and/or from other devices via a network such as the Internet.

FIG. 22 illustrates components of a computing device that may be used in certain implementations described herein. Referring to FIG. 22, system 2200 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, a holographic enabled device or a smart television. Accordingly, more or fewer elements described with respect to system 2200 may be incorporated to implement a particular computing device.

System 2200 includes a processing system 2205 of one or more processors to transform or manipulate data according to the instructions of software 2210 stored on a storage system 2215. Examples of processors of the processing system 2205 include general purpose central processing units, application specific processors, and logic devices, as well as any other type of processing device, combinations, or variations thereof. The processing system 2205 may be, or is included in, a system-on-chip (SoC) along with one or more other components such as network connectivity components, sensors, video display components.

The software 2210 can include an operating system and application programs such as a mixed reality collaboration application 2220 that may include components for communicating with collaboration service (e.g. running on server such as system 100 or system 900). Device operating systems generally control and coordinate the functions of the various components in the computing device, providing an easier way for applications to connect with lower level interfaces like the networking interface. Non-limiting examples of operating systems include Windows® from Microsoft Corp., Apple® iOS™ from Apple, Inc., Android® OS from Google, Inc., and the Ubuntu variety of the Linux OS from Canonical.

It should be noted that the operating system may be implemented both natively on the computing device and on software virtualization layers running atop the native device operating system (OS). Virtualized OS layers, while not depicted in FIG. 22, can be thought of as additional, nested groupings within the operating system space, each containing an OS, application programs, and APIs.

Storage system 2215 may comprise any computer readable storage media readable by the processing system 2205 and capable of storing software 2210 including the mixed reality collaboration application 2220.

Storage system 2215 may include volatile and nonvolatile, removable and non-removable media implemented in any method or technology for storage of information, such as computer readable instructions, data structures, program modules, or other data. Examples of storage media of storage system 2215 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a transitory propagated signal or carrier wave.

Storage system 2215 may be implemented as a single storage device but may also be implemented across multiple storage devices or sub-systems co-located or distributed relative to each other. Storage system 2215 may include additional elements, such as a controller, capable of communicating with processing system 2205.

Software 2210 may be implemented in program instructions and among other functions may, when executed by system 2200 in general or processing system 2205 in particular, direct system 2200 or the one or more processors of processing system 2205 to operate as described herein.

In general, software may, when loaded into processing system 2205 and executed, transform computing system 2200 overall from a general-purpose computing system into a special-purpose computing system customized to retrieve and process the information for facilitating content authoring as described herein for each implementation. Indeed, encoding software on storage system 2215 may transform the physical structure of storage system 2215. The specific transformation of the physical structure may depend on various factors in different implementations of this description. Examples of such factors may include, but are not limited to the technology used to implement the storage media of storage system 2215 and whether the computer-storage media are characterized as primary or secondary storage.

The system can further include user interface system 2230, which may include input/output (I/O) devices and components that enable communication between a user and the system 2200. User interface system 2230 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 2230 may also include output devices such as display screen(s), speakers, haptic devices for tactile feedback, and other types of output devices. In certain cases, the input and output devices may be combined in a single device, such as a touchscreen display which both depicts images and receives touch gesture input from the user. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

Visual output may be depicted on the display in myriad ways, presenting graphical user interface elements, text, images, video, notifications, virtual buttons, virtual keyboards, or any other type of information capable of being depicted in visual form.

The user interface system 2230 may also include user interface software and associated software (e.g., for graphics chips and input devices) executed by the OS in support of the various user input and output devices. The associated software assists the OS in communicating user interface hardware events to application programs using defined mechanisms. The user interface system 2230 including user interface software may support a graphical user interface, a natural user interface, or any other type of user interface. For example, the interfaces for the customization realty renovation visualization described herein may be presented through user interface system 2230.

Communications interface 2240 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

Computing system 2200 is generally intended to represent a computing system with which software is deployed and executed in order to implement an application, component, or service for mixed reality collaboration as described herein. In some cases, aspects of computing system 2200 may also represent a computing system on which software may be staged and from where software may be distributed, transported, downloaded, or otherwise provided to yet another computing system for deployment and execution, or yet additional distribution.

FIG. 23 illustrates components of a computing system that may be used to implement certain methods and services described herein. Referring to FIG. 23, system 2300 may be implemented within a single computing device or distributed across multiple computing devices or sub-systems that cooperate in executing program instructions. The system 2300 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 2300 can include a processing system 2320, which may include one or more processors and/or other circuitry that retrieves and executes software 2305 from storage system 2315. Processing system 2320 may be implemented within a single processing device but may also be distributed across multiple processing devices or sub-systems that cooperate in executing program instructions.

Examples of processing system 2320 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system(s) 2315 can include any computer readable storage media readable by processing system 2320 and capable of storing software 2305 including instructions for mixed reality collaboration service 2310. Storage system 2315 may include volatile and nonvolatile, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. In no case is the storage medium of storage system a transitory propagated signal or carrier wave.

In addition to storage media, in some implementations, storage system 2315 may also include communication media over which software may be communicated internally or externally. Storage system 2315 may be implemented as a single storage device but may also be implemented across multiple storage devices or sub-systems co-located or distributed relative to each other. Storage system 2315 may include additional elements, such as a controller, capable of communicating with processing system 2320.

In some cases, storage system 2315 includes data resource 2330. In other cases, the data resource 2330 is part of a separate system with which system 2300 communicates, such as a remote storage provider. For example, data, such as registered user information, supported device information, and session data, may be stored on any number of remote storage platforms that may be accessed by the system 2300 over communication networks via the communications interface 2325. Such remote storage providers might include, for example, a server computer in a distributed computing network, such as the Internet. They may also include “cloud storage providers” whose data and functionality are accessible to applications through OS functions or APIs.

Software 2305 may be implemented in program instructions and among other functions may, when executed by system 2300 in general or processing system 2320 in particular, direct the system 2300 or processing system 2320 to operate as described herein for a service 2310 receiving communications associated with a mixed reality collaboration application such as described herein.

Software 2305 may also include additional processes, programs, or components, such as operating system software or other application software. It should be noted that the operating system may be implemented both natively on the computing device and on software virtualization layers running atop the native device operating system (OS). Virtualized OS layers, while not depicted in FIG. 23, can be thought of as additional, nested groupings within the operating system space, each containing an OS, application programs, and APIs.

Software 2305 may also include firmware or some other form of machine-readable processing instructions executable by processing system 2320.

System 2300 may represent any computing system on which software 2305 may be staged and from where software 2305 may be distributed, transported, downloaded, or otherwise provided to yet another computing system for deployment and execution, or yet additional distribution.

In embodiments where the system 2300 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 2325 may be included, providing communication connections and devices that allow for communication between system 2300 and other computing systems (not shown) over a communication network or collection of networks (not shown) or the air.

Certain techniques set forth herein with respect to mixed reality collaboration may be described in the general context of computer-executable instructions, such as program modules, executed by one or more computing devices including holographic enabled devices. Generally, program modules include routines, programs, objects, components, and data structures that perform particular tasks or implement particular abstract data types.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Embodiments may be implemented as a computer process, a computing system, or as an article of manufacture, such as a computer program product or computer-readable medium. Certain methods and processes described herein can be embodied as software, code and/or data, which may be stored on one or more storage media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

Computer-readable media can be any available computer-readable storage media or communication media that can be accessed by the computer system.

Communication media include the media by which a communication signal containing, for example, computer-readable instructions, data structures, program modules, or other data, is transmitted from one system to another system. The communication media can include guided transmission media, such as cables and wires (e.g., fiber optic, coaxial, and the like), and wireless (unguided transmission) media, such as acoustic, electromagnetic, RF, microwave and infrared, that can propagate energy waves. Although described with respect to communication media, carrier waves and other propagating signals that may contain data usable by a computer system are not considered computer-readable “storage media.”

By way of example, and not limitation, computer-readable storage media may include volatile and non-volatile, removable and non-removable media implemented in any method or technology for storage of information such as computer-readable instructions, data structures, program modules or other data. Examples of computer-readable storage media include volatile memory such as random access memories (RAM, DRAM, SRAM); non-volatile memory such as flash memory, various read-only-memories (ROM, PROM, EPROM, EEPROM), phase change memory, magnetic and ferromagnetic/ferroelectric memories (MRAM, FeRAM), and magnetic and optical storage devices (hard drives, magnetic tape, CDs, DVDs). As used herein, in no case does the term “storage media” consist of transitory signals.

It should be understood that the examples described herein are for illustrative purposes only and that various modifications or changes in light thereof will be suggested to persons skilled in the art and are to be included within the spirit and purview of this application and not inconsistent with the descriptions and definitions provided herein.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims subject to any explicit definitions and disclaimers regarding terminology as provided above.

What is claimed is:

1. A system for performing mixed reality communication between multiple users, comprising:
a processing system;
a storage system operatively coupled with the processing system;
a data resource operatively coupled with the processing system;
supported device information stored on the data resource, the supported device information indicating devices and operating systems that the system can support and their corresponding application programming interface (API) calls;
registered user information stored on the data resource, the registered user information including user identifiers and device information; and
instructions for performing mixed reality communication between multiple users, stored on the storage system, that when executed by the processing system, direct the processing system to at least:
in response to receiving registration information from a first user device, store the registration information from the first user device in the data resource as part of the registered user information, wherein the registration information includes at least first user device information and first user information;
in response to receiving registration information from a second user device, store the registration information from the second user device in the data resource as part of the registered user information, wherein the registration information includes at least second user device information and second user information, and wherein the first user device and the second user device have different operating systems;
receive, from the second user device, session data in a format compatible with the second user device operating system; and
access the supported device information and communicate the session data to the first user device according to the API calls for the first user device.

2. The system of claim 1, wherein the instructions for performing mixed reality communication between multiple users further direct the processing system to:
create a collaboration session for both the first user device and the second user device; and
link both the first user device and the second user device to the collaboration session.

3. The system of claim 2, wherein the instructions for performing mixed reality communication between multiple users further direct the processing system to:
send an application library manifest to the first user device;
receive, from the first user device, a user selection of an application of the application library, the application being associated with the user of the second user device; and
initiate the link with the second user device, wherein initiating the link comprises sending a request to establish a connection to the second user device.

4. The system of claim 1, wherein the instructions that direct the processing system to access the supported device information and communicate the session data, direct the processing system to at least:
determine if the format of the session data is compatible with the first user device operating system;
if the format of the session data is not compatible with the first user device operating system, convert the session data to a format that is compatible with the first user device operating system; and
send the session data to the first user device.

5. The system of claim 1, wherein the session data is three-dimensional map data, wherein the three-dimensional map data defines a virtual environment associated with a user of the second user device.

6. The system of claim 1, wherein the session data is first manipulation data.

7. The system of claim 1, wherein the instructions for performing mixed reality communication between multiple users further direct the processing system to:
receive, from the first user device, second manipulation data in a format compatible with the first user device operating system; and
access the supported device information and communicate the second manipulation data to the second user device according to the API calls for the second user device.

8. The system of claim 7, wherein the instructions that direct the processing system to access the supported device information and communicate the second manipulation data, direct the processing system to at least:
determine if the format of the second manipulation data is compatible with the second user device operating system;
if the format of the second manipulation data is not compatible with the second user device operating system, convert the second manipulation data to a format that is compatible with the second user device operating system; and
send the second manipulation data to the second user device.

9. The system of claim 1, wherein the session data includes one or more of three-dimensional map data, environment data, geographic location data, sound data, video data, asset data, manipulation data, connection status data, time data, progress data, and preference data.

10. The system of claim 1, wherein the instructions for performing mixed reality communication between multiple users further direct the processing system to:
receive, from a third user device, third manipulation data in a format compatible with the third user device operating system; and
access the supported device information and communicate the third manipulation data to the first user device according to the API calls for the first user device and the second user device according to the API calls for the second user device.

11. A method for performing mixed reality communication between multiple users, the method comprising:
in response to receiving registration information from a first user device, storing the registration information from the first user device in a data resource as part of registered user information, wherein the registration information includes at least first user device information and first user information, and wherein the data resource comprises supported device information and the registered user information, the supported device information indicating devices and operating systems that a system for performing mixed reality communication between multiple users can support and their corresponding application programming interface (API) calls, and the registered user information including user identifiers and device information;
in response to receiving registration information from a second user device, storing the registration information from the second user device in the data resource as part of the registered user information, wherein the registration information includes at least second user device information and second user information, and wherein the first user device and the second user device have different operating systems;
receiving, from the second user device, session data in a format compatible with the second user device operating system; and
accessing the supported device information and communicating the session data to the first user device according to the API calls for the first user device.

12. The method of claim 11, further comprising:
creating a collaboration session for both the first user device and the second user device; and
linking both the first user device and the second user device to the collaboration session.

13. The method of claim 11, further comprising:
sending an application library manifest to the first user device;
receiving, from the first user device, a user selection of an application of the application library, the application being associated with the user of the second user device; and
initiating the link with the second user device, wherein initiating the link comprises sending a request to establish a connection to the second user device.

14. The method of claim 11, wherein the accessing the supported device information and communicating the session data further comprises:
determining if the format of the session data is compatible with the first user device operating system;
if the format of the session data is not compatible with the first user device operating system, converting the session data to a format that is compatible with the first user device operating system; and
sending the session data to the first user device.

15. The method of claim 11, wherein the session data is three-dimensional map data, wherein the three-dimensional map data defines a virtual environment associated with a user of the second user device.

16. The method of claim 11, wherein the session data is first manipulation data.

17. The method of claim 11, further comprising:
receiving, from the first user device, second manipulation data in a format compatible with the first user device operating system; and
accessing the supported device information and communicating the second manipulation data to the second user device according to the API calls for the second user device.

18. The method of claim 17, wherein the accessing the supported device information and communicating the second manipulation data further comprises:
determining if the format of the second manipulation data is compatible with the second user device operating system;
if the format of the second manipulation data is not compatible with the second user device operating system, converting the second manipulation data to a format that is compatible with the second user device operating system; and
sending the second manipulation data to the second user device.

19. The system of claim 11, wherein the session data includes one or more of three-dimensional map data, environment data, geographic location data, sound data, video data, asset data, manipulation data, connection status data, time data, progress data, and preference data.

20. The system of claim 11, further comprising tracking the session data.
